(19) United States
(12) Patent Application Publication
(10) Pub. No.: US 2018/0131936 A1
(43) Pub. Date: May 10, 2018

(54) CONVERSION BUFFER TO DECOUPLE NORMATIVE AND IMPLEMENTATION DATA PATH INTERLEAVING OF VIDEO COEFFICIENTS

(71) Applicant: Intel Corporation, Santa Clara, CA (US)

(72) Inventors: Wen TANG, Saratoga, CA (US); Iole MOCCAGATTA, San Jose, CA (US)

(21) Appl. No.: 15/348,783

(22) Filed: Nov. 10, 2016

(51) Int. Cl. H04N 19/124; H04N 19/15; H04N 19/13; H04N 19/159; H04N 19/88

(52) U.S. Cl. CPC H04N 19/124; H04N 19/15; H04N 19/176; H04N 19/159; H04N 19/88; H04N 19/13

(57) ABSTRACT

A video coder conversion buffer to decouple a normative coding order and a processing order for blocks of video coefficients for intra coding processing such video coefficients as well as interleaving schemes for the processing order are discussed.

### BACKGROUND

In compression/decompression (codec) systems, compression efficiency, video quality, and computational efficiency are important performance criteria. Furthermore, it is advantageous for bitstreams or other data representations of coded video to be standardized based on the H.264/MPEG-4 advanced video coding (AVC) standard, the high efficiency video coding (HEVC) standard, the VP9 coding standard, the Alliance for Open Media (AOM) standard, MPEG-4 standards, and extensions thereof.

Therefore, it may be advantageous to increase computational efficiency of encoders and decoders while maintaining standards based bitstreams or other data representations of coded video data. It is with respect to these and other considerations that the present improvements have been needed. Such improvements may become critical as the desire to compress and transmit video data becomes more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustration of an example prediction unit and corresponding transform units;

FIG. 2 is an illustration of example intra prediction loop dependencies;

FIG. 3 is an illustration of example transform unit pipeline processing;

FIG. 4 is an illustration of an example encoder;

FIG. 5 is an illustration of an example encoder conversion buffer;

FIG. 6 is an illustration of an example decoder;

FIG. 7 is an illustration of an example decoder conversion buffer;

FIG. 8 is an illustration of example processing orders including color interleaving;

FIG. 9 is an illustration of example processing orders including color interleaving;

FIGS. 10A-10C illustrate an example scanning and ordering of transform units of a prediction unit to provide a coding order;

FIGS. 11A and 11B illustrate an example scanning and ordering of transform units of a prediction unit to provide a coding order;

FIGS. 12A-12C illustrate an example scanning and ordering of transform units of a prediction unit to provide a coding order;

FIGS. 13A-13C illustrate an example scanning and ordering of transform units of a prediction unit to provide a coding order;

FIG. 14 is a flow diagram illustrating an example process for video coding including interleaving transform blocks by color into a processing order;

FIG. 15 is an illustrative diagram of an example system for video coding including interleaving transform blocks by color into a processing order;

FIG. 16 is an illustrative diagram of an example system; and

FIG. 17 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Methods, devices, apparatuses, computing platforms, and articles are described herein related to video coding and, in particular, to decoupling a normative data path or order with a processing data path or order for improved throughput.

The discussed techniques and systems may provide a conversion buffer to decouple normative and implementation data path interleaving of video codec coefficients and interleaving techniques schemes to be used in conjunction with such a conversion buffer to improve throughput of an encoder and/or decoder. For example, the conversion buffer and associated techniques may decouple how coefficients of different colors are interleaved in the actual bitstream of video codecs from the interleaving of the same coefficients in the implementation of such video codecs. The discussed techniques may be used in any suitable coding context such as in the implementation of H.264/MPEG-4 advanced video coding (AVC) standards based codecs, high efficiency video coding (H.265/HEVC) standards based codecs, Alliance for Open Media (AOM) standards based codecs such as the AV1 standard, MPEG standards based codecs such as the MPEG-4 standard, VP9 standards based codecs, or any other suitable codec or extension or profile thereof implemented via an encoder or decoder.

As discussed further herein, one or more buffers may be provided in the implementation of a video codec or codecs such that the order in which coefficients of different colors are interleaved in the actual bitstream of such video codec or codecs may be different from the interleaving of the same coefficients in portions of such video codec or codecs processing pipeline. The different order in the processing pipeline provides improved video throughput and performance while generating or processing a bitstream or bitstreams compliant to such video codec or codecs specifications. Therefore the discussed techniques improve throughput and performance while generating or processing standards based bitstreams that do not require normative changes thereto.

For example, a conversion buffer may be implemented to change the order in which luma (Y) and chroma (Cb and Cr or U and V) coefficients are interleaved to reduce the impact of intra prediction loop delay and increase throughput of reconstructed pixels processing. In the following, discussion is made with respect to intra prediction performed in the pixel domain (e.g., as in HEVC and its extensions and profiles, VP9 and its extensions and profiles, AV1 and its extensions and profiles). However, the following techniques and systems may be applied to codecs where intra prediction is performed in the transform domain (e.g., MPEG-4 Part 1). Furthermore, the techniques may be provided at an encoder and/or decoder to improve throughput and efficiency.

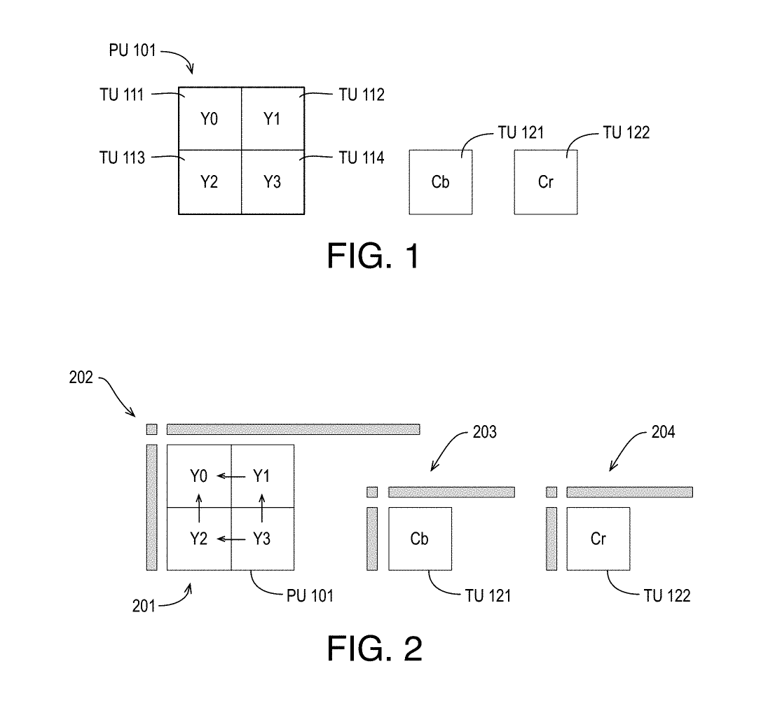

FIG. 1 is an illustration of an example prediction unit 101 and corresponding transform units, arranged in accordance with at least some implementations of the present disclosure. As shown in FIG. 1, prediction unit (PU) 101 may have four corresponding luma transform units (TUs) 111, 112, 113, 114 and two corresponding chroma transform units 121, 122. In the illustrated example, prediction unit 101 is a square block corresponding to four square luma transform units 111, 112, 113, 114 (labeled Y0, Y1, Y2, Y3) and two square chroma transform units 121, 122 (labeled Cb, Cr). Such an example may correspond to a 4:2:0 color sampling in the Y-Cb-Cr color space. However, prediction unit 101 may have any suitable shape such as rectangular and any suitable size. Furthermore, prediction unit 101 may have any number of corresponding luma transform units and chroma transform units of any suitable sizes. The techniques discussed herein may be applied to any color sampling structure such as 4:2:2 color sampling or 4:4:4 color sampling. Examples of such structures are discussed further herein. Also, any suitable color space may be used such as the Y-U-V color space. In the following, Y-Cb-Cr and Y-U-V color spaces are used interchangeably. The terms prediction unit and transform unit are used herein. However, such units of pixel samples, residual samples, transform coefficients, or the like may be characterized as blocks or the like. In codec systems, intra prediction may be performed across transform units such that a transform unit represents samples processed by a transform into a frequency domain.

FIG. 2 is an illustration of example intra prediction loop dependencies, arranged in accordance with at least some implementations of the present disclosure. As shown in FIG. 2 with respect to prediction unit 101, intra prediction loop dependencies 201 exist between transform units of prediction unit 101 such that reconstructed samples of transform unit Y0 are used in the intra prediction reconstruction of transform units Y1 and Y2 and reconstructed samples of transform units Y0, Y1, and Y2 are used in the intra prediction reconstruction of transform unit Y3. Furthermore, the reconstruction of prediction unit 101 is supported by previously reconstructed pixels 202, 203, 204. Such intra prediction loop dependencies 201 require that, before processing, a dependent transform unit, the prediction reconstruction of the transform unit(s) on which the dependent transform unit depend must be previously processed.

With reference to FIG. 1, the normative or standards based ordering of quantized transform coefficients of transform units for prediction unit 101 is as follows: Y0-Y1-Y2-Y3-Cb-Cr. If processed in such an order, the reconstruction of transform units 121, 122 (Cb and Cr samples) must wait until the processing of all luma transform units 111, 112, 113, 114 (Y0, Y1, Y2, Y3) are processed, causing delay. Furthermore, the smaller the transform unit, the longer the duration of such idle time.

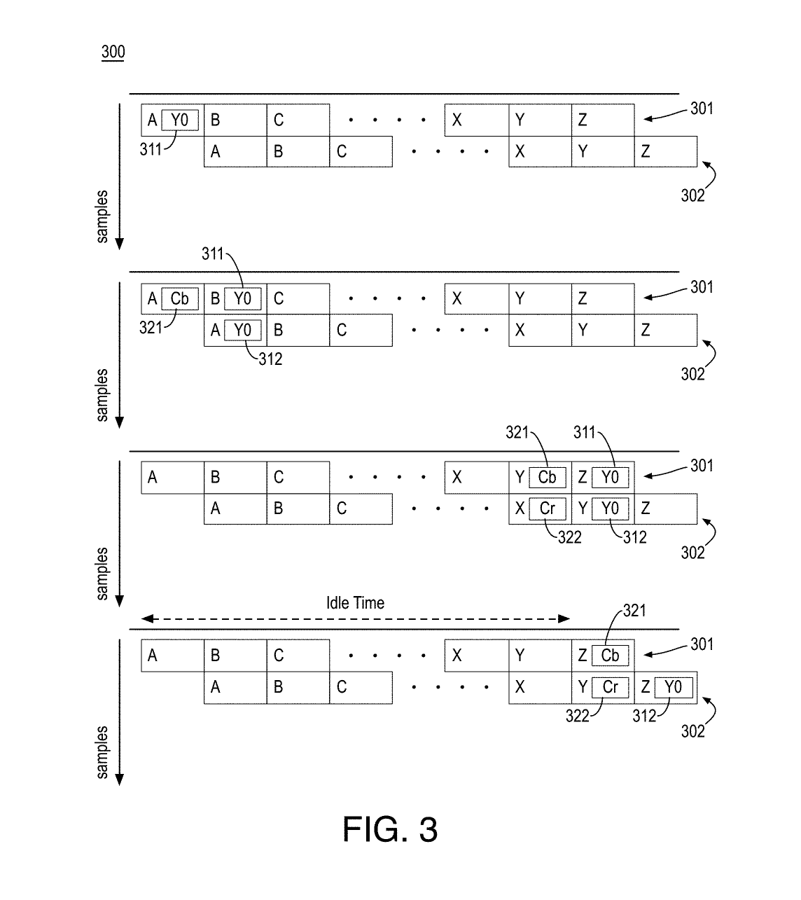

FIG. 3 is an illustration of example transform unit pipeline processing 300, arranged in accordance with at least some implementations of the present disclosure. FIG. 3 provides an illustration of inserting chroma processing between luma processing as will be discussed further herein. As shown in FIG. 3, a first sample 311 of luma transform unit 111 (Y0) may be introduced to stage A of a first pipeline 301 of pipeline processing 300. Subsequently, a last luma sample 312 of transform unit 111 (Y0) may be introduced to stage A of a second pipeline 302 and a chroma sample 321 (Cb) may be introduced to stage A of first pipeline 301 as first sample 311 is at stage B of first pipeline 301. Furthermore, although not shown, and a chroma sample 322 (Cr) of a second color channel may be introduced to stage A of second pipeline 302 as first luma sample 311 is at stage C of first pipeline 301, chroma sample 321 is at stage B of first pipeline 301, and last luma sample 312 is at stage B of second pipeline 302. As shown, as processing continues, chroma sample 322 is at stage Y of second pipeline 302, first luma sample 311 is at stage Z of first pipeline 301, chroma sample 321 is at stage Y of first pipeline 301, and last luma sample 312 is at stage Z of second pipeline 302. At the next processing stage, first luma sample 311 has completed processing and another sample from a next luma sample may be introduced. As shown, during idle time 311, processing of at least chroma samples 321, 322 may be provided to increase throughput.

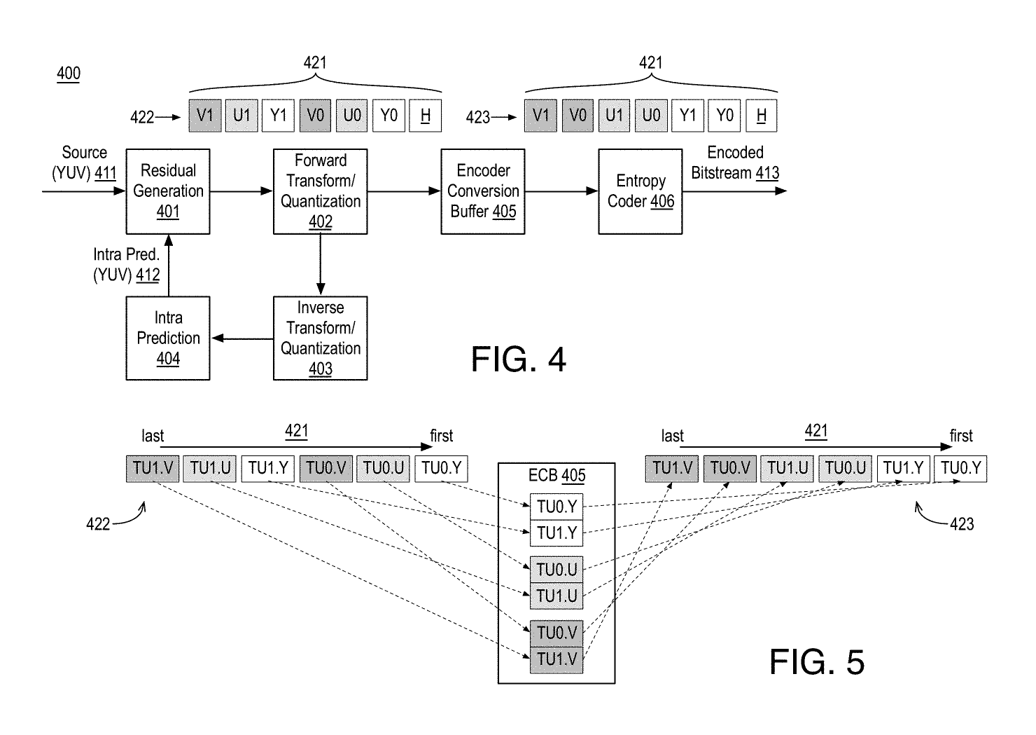

FIG. 4 is an illustration of an example encoder 400, arranged in accordance with at least some implementations of the present disclosure. As shown in FIG. 4, encoder 400 may include a residual generation module 401, a forward transform and quantization module 402, an inverse transform and quantization module 403, an intra prediction module 404, an encoder conversion buffer 405, an entropy coder 406. Residual generation module 401, forward transform and quantization module 402, inverse transform and quantization module 403, and intra prediction module 404 may be characterized as an intra prediction loop 409 or the like.

As shown, encoder 400 may receive source video (YUV) 411 for coding and may provide encoded bitstream 413 of encoded video data. Source video 411 may be in any suitable format such as YUV or YCbCr or the like and may have any suitable resolution, bit depth, etc. Encoded bitstream 413 may include any suitable data format. For example, encoded bitstream 413 may be a standards compliant format bitstream compliant with any standard discussed herein. Residual generation module 401 may difference source video 411 or portions thereof and intra prediction signal 412 to provide prediction residuals for intra coded prediction units. The intra coded prediction unit residuals are forward transformed and forward quantized by forward transform and quantization module 402 to generate quantized transform coefficients, which may inverse quantized and inverse transformed by inverse transform and quantization module 403 to generate reconstructed prediction residuals. The reconstructed prediction residuals are combined with corresponding prediction data (e.g., using intra prediction based on previously decoded pixel samples) by intra prediction module 404 to generate intra prediction signal 412. Such processing may be repeated for any number of prediction units or coding units or the like of video frames of source video 411.

Furthermore, the discussed forward transform, forward quantization, inverse quantization, and inverse transform processing may be performed on transform units such that transform units are sub-units of a prediction unit (or a transform unit may be an entire prediction unit). As shown in FIG. 4, an example prediction unit 421 processed by intra prediction loop 409 may be in a processing order 422. Processing order 422 may also be characterized as an intra processing order, a hardware pipeline order, an internal color interleaving, or the like. As shown, processing order 422 includes transform units (labeled Y0, U0, V0, Y1, U1, V1) along with a header (H) in an interleaved order for more efficient processing by intra prediction loop 409. For example, in intra prediction loop 409, color coefficients are interleaved on a transform color unit by transform color unit color basis (e.g., on a TU.color by TU.color basis) such that the transform color unit is used for intra prediction by the components of intra prediction loop 409. The example of processing order 422 represents prediction unit 421 having two transform units of equal size: TU0 and TU1. Furthermore, each transform unit has three color coefficient blocks: TU.Y, TU.U, and TU.V. For example, prediction unit 421 may be a rectangular prediction unit having two square transform units implemented at 4:4:4 color sampling.

Also as shown, encoder conversion buffer 405 may be implemented to change the order of transform units of prediction unit 421 to a normative coding order 423. For example, encoder conversion buffer 405 decouples how coefficients of different colors are interleaved in a standards compliant bitstream (encoded bitstream 413) from an interleaving of the same coefficients in an implementation (processing order 422). In an embodiment, encoder conversion buffer 405 translates coefficients of transform units from an internal color interleaving (processing order 422) to an external color interleaving (normative coding order 423). Normative coding order 423 may also be characterized as a standards based order, an output coding order, an external color interleaving, or the like. For example, entropy coder 406 may process prediction unit 421 to generate a standards compliant encoded bitstream 413 with prediction units presented in normative coding order 423. Entropy coder 406 may generate encoded bitstream 413 using any suitable technique or techniques. For example, entropy coder 406 may use samples-to-bin/bit processing such as multi-level or binary entropy/arithmetic encoding or the like. The techniques discussed herein, by providing prediction unit 421 in normative coding order 423 may provide for such entropy encoding to be performed using standards or normative based techniques to generate a standards compliant encoded bitstream 413.

As shown, processing order 422 may be provided in the following order: header (H)-TU0.Y (Y0)-TU0.U (U0)-TU0.V (V0)-TU1.Y (Y1)-TU1.U (U1)-TU1.V (V1), and normative coding order 423 may be provided as header (H)-TU0.Y (Y0)-TU1.Y (Y1)-TU0.U (U0)-TU1.U (U1)-TU0.V (V0)-TU1.V (V1). Example processing orders are discussed further herein below. As will be appreciated, normative coding order 423 and processing order 422 differ in how the coefficient units or blocks are interleaved such that processing by intra prediction loop 409 may be performed more efficiently.

As discussed, processing order 422 may reduce the processing time required to process prediction unit 421 by eliminating delays with respect to processing in normative coding order 423. For example, the processing of U0 immediately following Y0 may reduce delay as U0 does not wait for the completion of Y1 (which may in turn may need to wait for Y0). Similarly, the processing of V0 immediately following U0 may reduce delay as V0 does not wait for the completion of Y1.

FIG. 5 is an illustration of an example encoder conversion buffer 405, arranged in accordance with at least some implementations of the present disclosure. As shown in FIG. 5, encoder conversion buffer 405 may receive transform units of prediction unit 421 in processing order 422 (TU0.Y, TU0.U, TU0.V, TU1.Y, TU1.U, TU1.V) and transform units of prediction unit 421 may be retrieved in normative coding order 423 (TU0.Y, TU1.Y, TU0.U, TU1.U, TU0.V, TU0.V). For example, a processor (not shown) such as a central processor or video processor or the like may store blocks of quantized residual transform coefficients corresponding to transform units of prediction unit 421 in processing order 422 (or any other processing order discussed herein) and the processor or another processor may retrieve the blocks of quantized residual transform coefficients corresponding to transform units of prediction unit 421 in normative coding order 423.

As discussed, encoder conversion buffer 405 may be used to convert from TU-level color interleaving to PU-level color interleaving on the PU by PU basis. Encoder conversion buffer 405 may store the input TU.color blocks by color in the input sequence. Furthermore, encoder conversion buffer 405 may store and/or track the transform units in a prediction unit and the transform color units in a transform unit. For example, encoder conversion buffer 405 may detect all transform units of a prediction unit are received and output all transform luma units (e.g., all transform unit luma blocks), followed by all transform U units (e.g., all transform unit U or Cb blocks), followed by all transform V units (e.g., all transform unit V or Cr blocks).

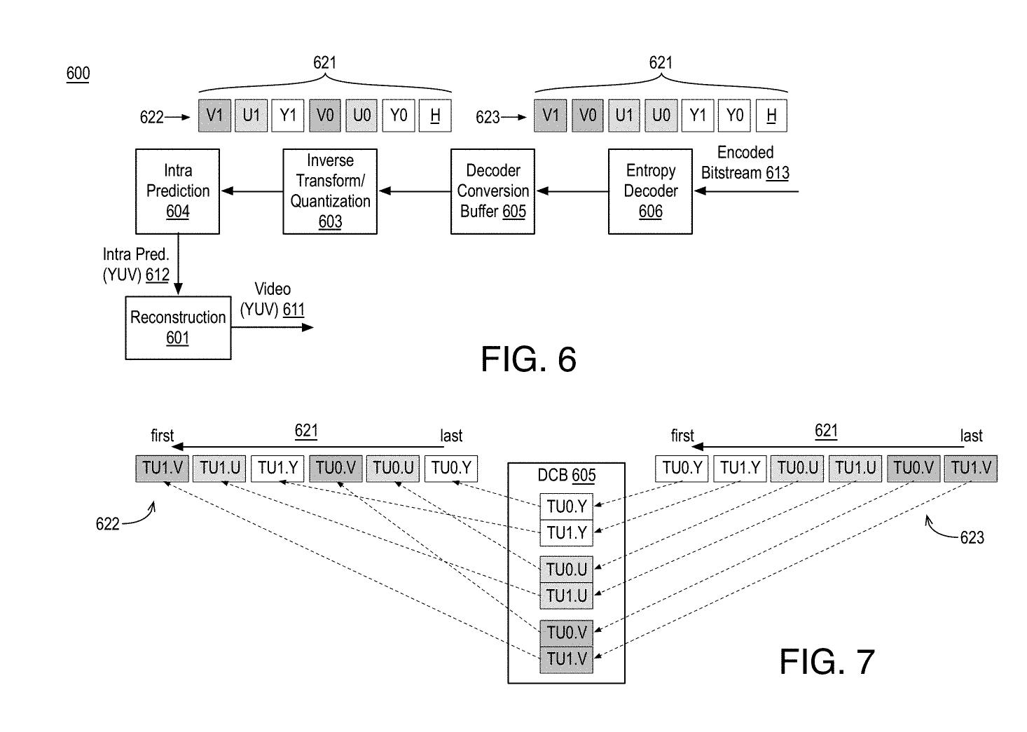

FIG. 6 is an illustration of an example decoder 600, arranged in accordance with at least some implementations of the present disclosure. As shown in FIG. 6, decoder 600 may include an entropy decoder 606, a decoder conversion buffer 605, an inverse transform and quantization module 603, an intra prediction module 604, and a reconstruction module 601. As shown, decoder 600 may receive an encoded bitstream 613 for decoding and may provide reconstructed video (YUV) 611 for storage or presentment or the like. Encoded bitstream 613 may include any suitable data format. For example, encoded bitstream 613 may be a standards compliant format bitstream compliant with any standard discussed herein.

As shown, entropy decoder 606 may receive encoded bitstream 613 and may process encoded bitstream 613 to generate prediction unit 621 having transform unit data in a normative coding order 623. For example, entropy decoder 606 may decode encoded bitstream 613 to generate prediction unit 621. Entropy decoder 606 may decode encoded bitstream 613 to generate prediction unit 621 using any suitable technique or techniques. The techniques discussed herein with respect to decoder conversion buffer 605 may not impact the processing of entropy decoder 606. For example, entropy decoder may provide bin/bit to samples processing or the like. In an embodiment, prediction unit 621 may include transformed and quantized residual coefficients for transform units such that the transform units are in normative coding order 623. In analogy with the example presented in FIGS. 4 and 5, the example of processing order 624 represents prediction unit 621 having two transform units of equal size: TU0 and TU1. Furthermore, each transform unit has three color coefficient blocks: TU.Y, TU.U, and TU.V. For example, prediction unit 421 may be a rectangular prediction unit having two square transform units implemented at 4:4:4 color sampling.

Also as shown, decoder conversion buffer 605 may be implemented to change the order of transform units of prediction unit 621 to a processing order 622. For example, as discussed with respect to encoder conversion buffer 405, decoder conversion buffer 605 decouples how coefficients of different colors are interleaved in a standards compliant bitstream (encoded bitstream 613) from an interleaving of the same coefficients in an implementation (processing order 622). Decoder conversion buffer 605 may translate coefficients of transform units from an internal color interleaving (processing order 622) to an external color interleaving (normative coding order 623). Normative coding order 623 may also be characterized as a standards based order, an output coding order, an external color interleaving, or the like. As shown, normative coding order 623 may be provided as header (H)-TU0.Y (Y0)-TU1.Y (Y1)-TU0.U (U0)-TU1.U (U1)-TU0.V (V0)-TU1.V (V1), and processing order 622 may be provided as header (H)-TU0.Y (Y0)-TU0.U (U0)-TU0.V (V0)-TU1.Y (Y1)-TU1.0 (U1)-TU1.V (V1). Example processing orders are discussed further herein below. As will be appreciated, normative coding order 623 and processing order 622 differ in how the coefficient units or blocks are interleaved such that processing by decoder 600 may be performed more efficiently.

In processing a prediction unit in processing order 622, quantized transform coefficients of transform units of prediction unit 621 may be inverse quantized and inverse transformed by inverse transform and quantization module 603 to generate reconstructed prediction residuals for the transform units. The reconstructed prediction residuals are combined with corresponding prediction data (e.g., using intra prediction based on previously decoded pixel samples) by intra prediction module 604 to generate intra prediction signal 612. Such intra predicted prediction units may be processed by reconstruction module 601 to generate output frames or images of reconstructed video 611, which may be stored or presented or the like.

FIG. 7 is an illustration of an example decoder conversion buffer 605, arranged in accordance with at least some implementations of the present disclosure. As shown in FIG. 7, decoder conversion buffer may receive transform units of prediction unit 621 in normative coding order 623 (TU1.Y, TU1.Y, TU0.U, TU1.U, TU0.V, TU1.V) and transform units of prediction unit 621 may be retrieved in processing order 622 (TU0.Y, TU0.U, TU0.V, TU1.Y, TU1.U, TU1.V). For example, a processor (not shown) such as a central processor or video processor or the like may store blocks of quantized residual transform coefficients corresponding to transform units of prediction unit 621 in normative coding order 623 (or any other processing order discussed herein) and the processor or another processor may retrieve the blocks of quantized residual transform coefficients corresponding to transform units of prediction unit 621 in processing order 622. As discussed, decoder conversion buffer 605 may be used to convert from PU-level color interleaving on the PU by PU basis to TU-level color interleaving. Decoder conversion buffer 605 may provide the reverse of the conversion discussed with respect to encoder conversion buffer 405 to convert from PU-level color interleaving to internal color interleaving. In an embodiment, decoder conversion buffer 605 stores incoming TU.color blocks by color and, when all TU. color blocks of a TU are received, decoder conversion buffer 605 may provide those blocks in the order of Y followed by U and V or any other processing order as discussed herein.

As discussed, encoder 400 may implement an encoder conversion buffer 405 and decoder 600 may implement a corresponding decoder conversion buffer 605 to translate between normative coding orders and processing orders for transform units of a prediction unit. The processing orders discussed herein may interleave Y and Cb/Cr on a transform unit basis such that a transform unit represents a block (e.g., a square block) of samples processed by a transform. Since intra prediction reconstruction is performed across transform unit boundaries, such interleaving may allow for intra prediction reconstruction of Y, Cb, and Cr samples to progress in parallel, thus reducing the intra prediction loop delay. Such color interleaving schemes are discussed in the following for use in conjunction with the discussed encoder and decoder conversion buffers. Such color interleaving techniques may reduce intra prediction throughput and improve processing efficiency.

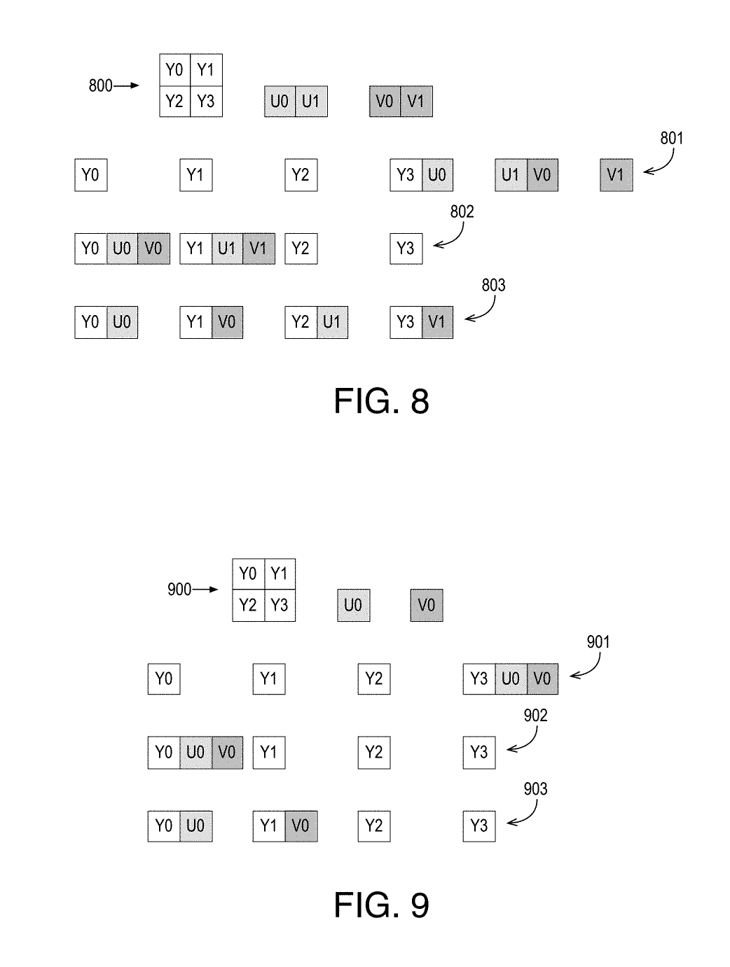

FIG. 8 is an illustration of example processing orders including color interleaving, arranged in accordance with at least some implementations of the present disclosure. FIG. 8 illustrates example processing orders 801, 802, 803 each for a prediction unit 800 having four luma transform units (Y0, Y1, Y2, Y3), two chroma channel one transform units (U0, U1), and two chroma channel two transform units (V0, V1). As used herein the terms chroma channel one and chroma channel two may refer to first and second chroma channels such as U and V channels, Cb and Cr channels, or the like. The illustrated example may provide transform units for a 4:2:2 color sampling. The illustrated transform units may have any suitable size such as a size of 4×4 pixel samples or transform coefficients. Furthermore, as discussed herein, the illustrated transform units may have a normative coding order or standards based coding order or the like in the following order: Y0, Y1, Y2, Y3, U0, U1, V0, V1.

In an embodiment, processing order 801 for prediction unit 800 may be provided with the processing order following the normative coding order such that the transform units of prediction unit 800 pack all luma transform units (e.g., Y0, Y1, Y2, Y3), then all chroma channel one transform units (e.g., U0, U1), then all chroma channel two transform units (e.g., V0, V1).

As shown, in an embodiment, processing order 802 for prediction unit 800 may be provided by packing as many groups of a luma transform unit, a chroma channel one transform unit, and a chroma channel two transform unit as available (e.g., until any of such transform units are exhausted), and then packing any available luma transform units. For example, processing order 802 may order the transform units with a first luma transform unit followed immediately by a first chroma channel one transform unit, which, in turn, is followed immediately by a first chroma channel two transform unit (e.g., Y0, U0, V0). As used herein, the term followed immediately or similar terms are meant to indicate no intervening units are between the units in the order. Subsequent groups of a subsequent luma transform unit followed immediately by a subsequent chroma channel one transform unit followed immediately by a subsequent chroma channel two transform unit may also be provided until, in this example, the chroma transform units are exhausted. Then, remaining luma transform units may be packed into processing order 802. For example, processing order 802, as shown, provides a sub-group of Y0, U0, V0 followed by a contiguous sub-group of Y1, U1, V1, which exhausts all of the chroma transform units, and then remaining luma transform units: Y2, Y3.

In an embodiment, processing order 803 for prediction unit 800 may be provided by packing as many groups of a luma transform unit, a chroma channel one transform unit, a luma transform unit, and a chroma channel two transform unit as available (e.g., until any of such transform units are exhausted), and then packing any available luma transform units or any available chroma transform units. For example, processing order 803 may order the transform units with a first luma transform unit followed immediately by a first chroma channel one transform unit, which, in turn, is followed immediately by a second luma transform unit, which, in turn is followed immediately by a first chroma channel two transform unit (e.g., Y0, U0, Y1, V0). Subsequent groups of a subsequent luma transform unit followed immediately by a subsequent chroma channel one transform unit followed immediately by another subsequent luma transform unit followed immediately by a subsequent chroma channel two transform unit may also be provided until, in this example, the chroma transform units are exhausted. Then, remaining luma transform units may be packed into processing order 803. For example, processing order 803, as shown, provides a sub-group of Y0, U0, Y1, V0 followed by a contiguous sub-group of Y2, U1, Y3, V1, which exhausts all of the transform units.

In the examples of FIG. 8, processing orders 801, 802, 803 do not modify the processing order of the luma transform units with respect to the normative coding order of such transform units used in a variety of video codecs. Furthermore, FIG. 8 illustrates the significance of processing orders 802, 803 with respect to processing order 801 in terms of throughput as processing delays caused by waiting for luma transform units Y0, Y1, Y2, Y3 to finish processing in processing order 801 are used to process chroma channel one and two transform units thus saving overall processing time.

FIG. 9 is an illustration of example processing orders including color interleaving, arranged in accordance with at least some implementations of the present disclosure. FIG. 9 illustrates example processing orders 901, 902, 903 each for a prediction unit 00 having four luma transform units (Y0, Y1, Y2, Y3), two chroma channel one transform units (U0, U1), and two chroma channel two transform units (V0, V1). The illustrated example may provide transform units for a 4:2:0 color sampling. The illustrated transform units may have any suitable size such as a size of 4×4 pixel samples or transform coefficients. Furthermore, as discussed herein, the illustrated transform units may have a normative coding order or standards based coding order or the like in the following order: Y0, Y1, Y2, Y3, U0, V0.

In an embodiment, processing order 901 for prediction unit 900 may be provided with the processing order following the normative coding order such that the transform units of prediction unit 900 pack all luma transform units (e.g., Y0, Y1, Y2, Y3), then all chroma channel one transform units (e.g., U0), then all chroma channel two transform units (e.g., V0).

In another embodiment, processing order 902 for prediction unit 900 may be provided by packing as many groups of a luma transform unit, a chroma channel one transform unit, and a chroma channel two transform unit as available (e.g., until any of such transform units are exhausted), and then packing any available luma transform units. Such ordering follow a similar packing technique as discussed with respect to processing order 802. For example, processing order 902 may order the transform units with a first luma transform unit followed immediately by a first chroma channel one transform unit, which, in turn, is followed immediately by a first chroma channel two transform unit (e.g., Y0, U0, V0). Subsequent groups of a subsequent luma transform unit followed immediately by a subsequent chroma channel one transform unit followed immediately by a subsequent chroma channel two transform unit may also be provided.

However, in this example, the chroma transform units are exhausted after the first grouping. Subsequently, remaining luma transform units may be packed into processing order 902. For example, processing order 902, as shown, provides a sub-group of Y0, U0, V0, which exhausts all of the chroma transform units, followed by remaining luma transform units: Y1, Y2, Y3.

In an embodiment, processing order 903 for prediction unit 900 may be provided by packing as many groups of a luma transform unit, a chroma channel one transform unit, a luma transform unit, and a chroma channel two transform unit as available (e.g., until any of such transform units are exhausted), and then packing any available luma transform units or any available chroma transform units. Such ordering follow a similar packing technique as discussed with respect to processing order 803. For example, processing order 903 may order the transform units with a first luma transform unit followed immediately by a first chroma channel one transform unit, which, in turn, is followed immediately by a second luma transform unit, which, in turn is followed immediately by a first chroma channel two transform unit (e.g., Y0, U0, Y1, V0). Subsequent groups of a subsequent luma transform unit followed immediately by a subsequent chroma channel one transform unit followed immediately by another subsequent luma transform unit followed immediately by a subsequent chroma channel two transform unit may also be provided. However, in this example, the chroma transform units are exhausted after the first sub group of Y0, U0, Y1, V1. Subsequently, remaining luma transform units may be packed into processing order 903. For example, processing order 903, as shown, provides a sub-group of Y0, U0, Y1, V0, which exhausts all of the chroma transform units, and then remaining luma transform units: Y2, Y3.

As with the examples of FIG. 8, the examples of FIG. 9 do not modify the processing order of the luma transform units with respect to the normative coding order used in a variety of video codecs. Furthermore, FIG. 9 again illustrates the significance of processing orders 902, 903 with respect to processing order 901 in terms of throughput as processing delays caused by waiting for luma transform units Y0, Y1, Y2, Y3 to finish processing in processing order 901 are used to process chroma channel one and two transform units thus saving overall processing time.

As discussed the examples of FIG. 8 may be used with 4:2:2 color sampling and the examples of FIG. 9 may be used with 4:2:0 color sampling. In the context of 4:4:4 color sampling, the discussed techniques for transform unit packing may be used. For example, the techniques discussed with respect to processing orders 802, 902 may be used to interleave a normative coding order of Y0, Y1, Y2, Y3, U0, U1, U2, U3, V0, V1, V2, V3 to a processing coding order of Y0, U0, V0, Y1, U1, V1, Y2, U2, V2, Y3, U3, V3 by packing as many groups of a luma transform unit, a chroma channel one transform unit, and a chroma channel two transform unit as available. Furthermore, the techniques discussed with respect to processing orders 803, 903 may be used to interleave a normative coding order of Y0, Y1, Y2, Y3, U0, U1, U2, U3, V0, V1, V2, V3 to a processing coding order of Y0, U0, Y1, V0, Y2, U1, Y3, U1, U2, V2, U3, V3 by packing as many groups of a luma transform unit, a chroma channel one transform unit, and a chroma channel two transform unit until any of such transform units are exhausted and then packing any available luma transform units or any available chroma transform units.

Also as discussed, the examples of FIGS. 8 and 9 do not modify the processing order of luma transform units with respect to the normative coding order of such luma transform units. In other examples, the processing order of luma transform units may be modified.

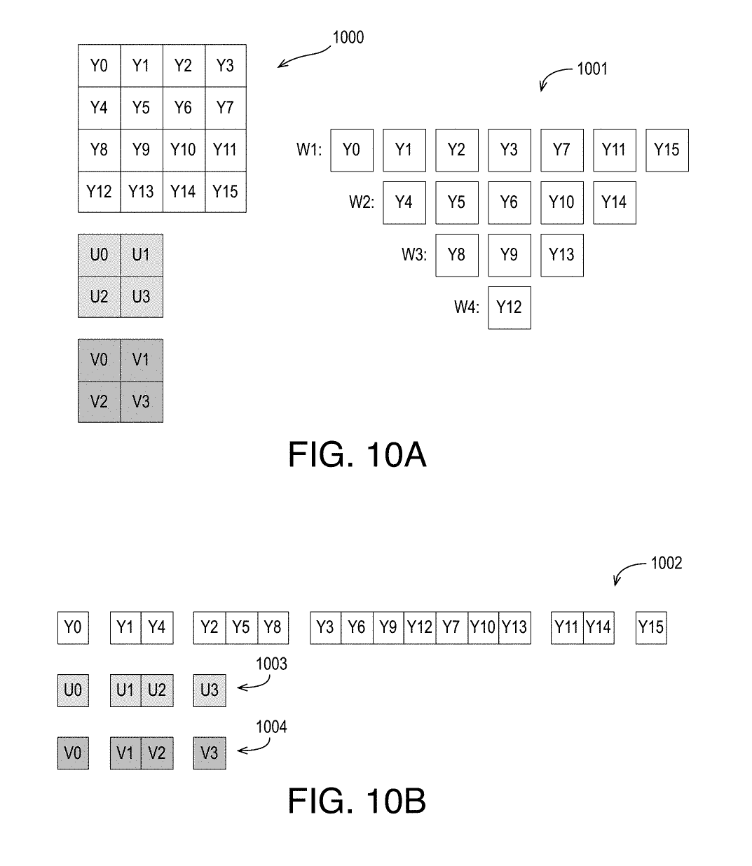

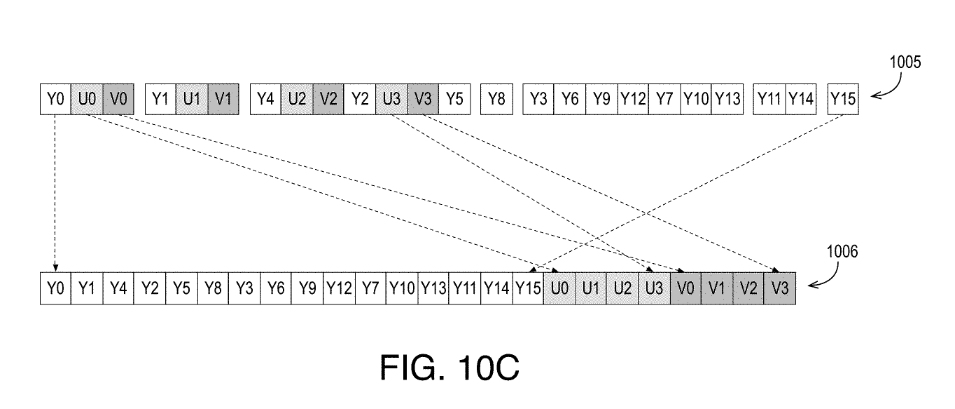

FIGS. 10A-10C illustrate an example scanning and ordering of transform units of a prediction unit to provide a coding order, arranged in accordance with at least some implementations of the present disclosure. For example, the processing order as provided by FIGS. 10A-10C may be compatible with intra prediction modes that do not use top right samples. As shown in FIG. 10A, an example prediction unit 1000 may include 16 transform units (Y0-Y15), four chroma channel one transform units (U0-U4), and four chroma channel two transform units (V0-V4). The illustrated example may provide transform units for a 4:2:0 color sampling. The illustrated transform units may have any suitable size such as a size of 4×4 pixel samples or transform coefficients. Furthermore, as discussed herein, the illustrated transform units may have a normative coding order or standards based coding order or the like in the following order: Y0-Y15, U0-U4, V0-V4.

Also as shown in FIG. 10A, luma transform units of prediction unit 1000 may be scanned in a wave-front order to provide a propagation order 1001. For example, luma transform units of prediction unit 1000 may be scanned in the following order. A first wave may scan from an upper-left transform unit (Y0) to the right and then down to a bottom-right transform unit (Y15) such that that the first scan attains the following luma transform units in order: Y0, Y1, Y2, Y3, Y7, Y11, Y15 as shown in Wave 1 (W1) of propagation order 1001. A second wave may scan the remaining transform units again from (an available) upper-left transform unit (Y4) to the right and then down to a bottom-right transform unit (Y14) such that that the second scan attains the following luma transform units in order: Y4, Y5, Y6, Y10, Y14 as shown in Wave 1 (W1). Third and fourth waves may again scan the remaining transform units from (an available) upper-left transform unit (Y8) to the right and then down to a bottom-right transform unit (Y13) such that the third scan attains the following luma transform units in order: Y8, Y9, Y13 and then the final available transform unit (Y12) such that the fourth scan attains the Y12 luma transform unit.

As shown in FIG. 10B, luma transform units of prediction unit 1000 in propagation order 1001 may then be translated to a luma processing order 1002 such that luma processing order 1002 provides a time order for processing as discussed herein with provided time gaps such as time gap 1011 to fulfill neighbor dependencies. For example, luma processing order 1002 may be generated from propagation order 1001 by scanning propagation order 1001 starting from a left of propagation order 1001 and scanning each column vertically from top to bottom, moving from left to right to the next column (along a row), scanning the column vertically, and so on. For example, the first column scan may provide luma transform unit Y0, the second column scan may provide luma transform units Y1, Y4, the third column scan may provide luma transform units Y2, Y5, Y8, and so on as shown in luma processing order 1002. Such wave-front scanning followed by column wise scanning of the luma transform units may provide for an ordering that does not violate dependencies between luma transform units based on intra prediction modes that do not use top right samples. Also as shown in FIG. 10B, chroma channel one transform units may be provided in an chroma channel one transform unit order 1003 matching the normative coding order. Similarly, chroma channel two transform units may be provided in an chroma channel two transform unit order 1004 matching the normative coding order.

The processing discussed with respect to FIGS. 10A and 10B to generate luma processing order 1002 may be generated by performing multiple spatially down-left oriented scans each beginning at a subsequent luma transform unit of the wave-front of transform units including Y0, Y1, Y2, Y3, Y7, Y11, Y15. For example, a first down-left oriented scan may begin at luma transform unit Y0 and may attain only luma transform unit Y0. A second down-left oriented scan may begin at luma transform unit Y1 (e.g., the transform unit in the top row and immediately to the left of the previous beginning luma transform unit) and may, by scanning down-left, attain luma transform units Y1, Y4. Similarly, a third down-left oriented scan may begin at luma transform unit Y2 (e.g., the transform unit in the top row and immediately to the left of the previous beginning luma transform unit, Y1) and may, by scanning in a down-left orientation, attain luma transform units Y2, Y5, Y8. An analogous fourth scan may attain luma transform units Y3, Y6, Y9, Y12. The scan beginning luma transform unit may now move downwardly in the wave-front order to luma transform unit Y7 and the fifth down-left oriented scan may attain luma transform units Y7, Y10, Y13. Similar sixth and seventh scans may attain luma transform units Y11, Y14 and Y15, respectively.

Turning now to FIG. 10C, a processing order 1005 for the transform units of prediction unit 1000 is provided based on the techniques discussed with respect to processing orders 802, 902. For example, processing order 1005 may be formed by packing as many groups of a luma transform unit, a chroma channel one transform unit, and a chroma channel two transform unit as available (e.g., until any of such transform units are exhausted), and then packing any available luma transform units. In the discussed context, such ordering may provide for processing order 1005 as follows: Y0, U0, V0, Y1, U1, V1, Y4, U2, V2, Y2, U3, V3, Y5, Y8, Y3, Y6, Y9, Y12, Y7, Y10, Y13, Y11, Y14, Y15. FIG. 10C also illustrates a translation from processing order 1005 to normative coding order 1006, which is in the order discussed above: Y0-Y15, U0-U3, V0-V3. As will be appreciated, performing intra prediction in processing order 1005 having less idle time and more efficient processing. As discussed, such processing order 1005 may be used at either or both of an encoder and a decoder based on implementation of a coding buffer as discussed herein. For example, transform units or blocks in processing order 1005 may be input into encoder conversion buffer 405 (after intra processing) and retrieved from encoder conversion buffer 405 in normative coding order 1006 for entropy coding into a standards compliant bitstream. Similarly, transform units or blocks in normative coding order 1006 may be input into decoder conversion buffer 605 (after entropy decoding) and retrieved from decoder conversion buffer 605 in processing order 1005 for intra processing as discussed herein.

In another embodiment, a coding order may be generated based on the techniques discussed with respect to processing orders 803, 903. For example, a processing order may be formed by packing as many groups of a luma transform unit, a chroma channel one transform unit, a luma transform unit, and a chroma channel two transform unit as available (e.g., until any of such transform units are exhausted), and then packing any available luma transform units or any available chroma transform units. In the discussed context, such ordering may provide for a coding order as follows: Y0, U0, Y1, V0, Y4, U1, Y2, V1, Y5, U2, Y8, V2, Y3, U3, Y6, V3, Y9, Y12, Y7, Y10, Y13, Y11, Y14, Y15.

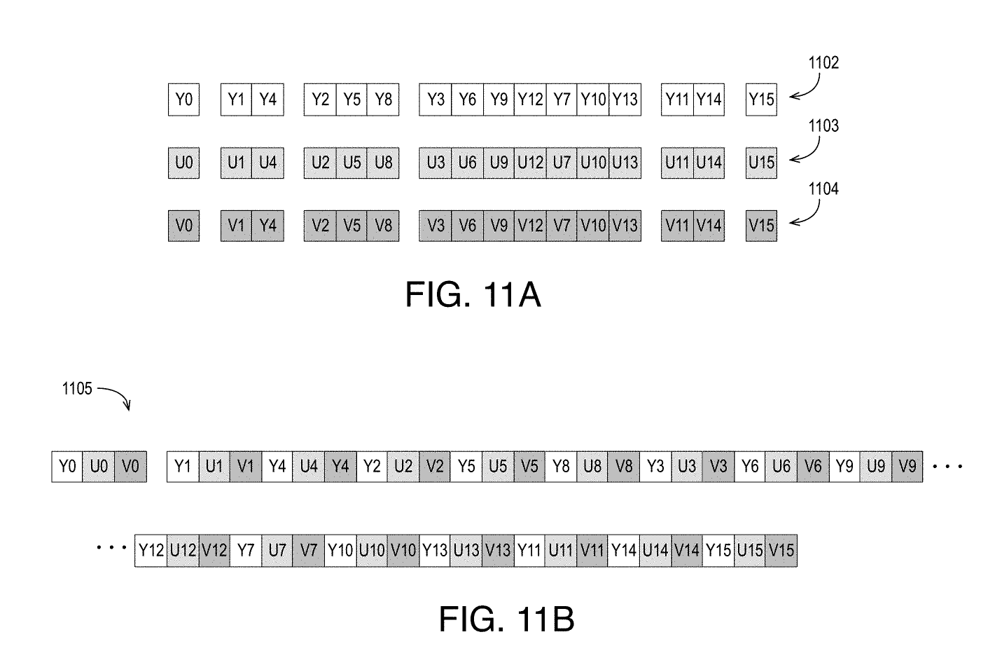

FIGS. 11A and 11B illustrate an example scanning and ordering of transform units of a prediction unit to provide a coding order, arranged in accordance with at least some implementations of the present disclosure. For example, the processing order as provided by FIGS. 11A and 11B may be compatible with intra prediction modes that do not use top right samples and may provide an example for a 4:4:4 color sampling. With reference to FIG. 10A, an example prediction unit may include 16 transform units (Y0-Y15). Furthermore, with a 4:4:4 color sampling, the prediction unit may include 16 chroma channel one transform units (U0-U15) and 16 chroma channel two transform units (V0-V15) arranged as illustrated with respect to the luma transform units of prediction unit 1000. The transform units may have any suitable size such as a size of 4×4 pixel samples or transform coefficients. Furthermore, as discussed herein, the illustrated transform units may have a normative coding order or standards based coding order or the like in the following order: Y0-Y15, U0-U15, V0-V15.

With continued reference to FIG. 10A, luma transform units may be scanned in a wave-front order to provide a propagation order 1001 as discussed. Similarly, chroma channel one transform units and chroma channel two transform units may be scanned in the wave-front order to provide chroma channel propagation orders analogous to propagation order 1001. For example, the chroma channel one propagation order may be U0, U1, U4, U2, U5, U8, U3, U6, U9, U12, U7, U10, U13, U11, U14, U15 and the chroma channel two propagation order may be V0, V1, V4, V2, V5, V8, V3, V6, V9, V12, V7, V10, V13, V11, V14, V15. Propagation order 1001 and the analogous chroma channel propagation orders are illustrated in FIG. 11A as luma processing order 1102, chroma channel one transform unit order 1103, and chroma channel two transform unit order 1104. As discussed with respect to FIGS. 10A-10C, such transform unit ordering may provide for an ordering that does not violate dependencies between transform units based on intra prediction modes that do not use top right samples.

Turning now to FIG. 11B, a processing order 1105 for the transform units of the discussed prediction unit (i.e., having 4:4:4 color sampling with 16 luma blocks, 16 chroma one blocks, and 16 chroma two blocks) is provided based on the techniques discussed with respect to processing orders 802, 902. For example, processing order 1105 may be formed by packing as many groups of a luma transform unit, a chroma channel one transform unit, and a chroma channel two transform unit as available (e.g., until any of such transform units are exhausted). In the illustrated example, with equal numbers of luma and chroma transform units, the transform units are exhausted simultaneously using such grouping techniques. In the discussed context, such ordering may provide for processing order 1005 as follows: Y0, U0, V0, Y1, U1, V1, Y4, U4, V4, Y2, U2, V2, Y5, U5, V5, Y8, U8, V8, Y3, U3, V3, Y6, U6, V6, Y9, U9, V9, Y12, U12, V12, Y7, U7, V7, Y10, U10, V10, Y13, U13, V13, Y11, U11, V11, Y14, U14, V14, Y15, U15, V15. It is noted that transform units V9 and Y12 are immediately adjacent to one another although illustrated separately for the sake of clarity of presentation. As discussed with respect to FIG. 10C, a translation from processing order 1105 to a normative coding order of Y0-Y15, U0-U15, V0-V15 may be provided by an encoder and/or decoder using the conversion buffers discussed herein.

As discussed, the processing orders discussed with respect to FIGS. 10A-10C and 11A and 11B may be compatible with intra prediction modes that do not use top right samples. Discussion now turns to processing orders that are compatible with intra prediction modes that use top right samples.

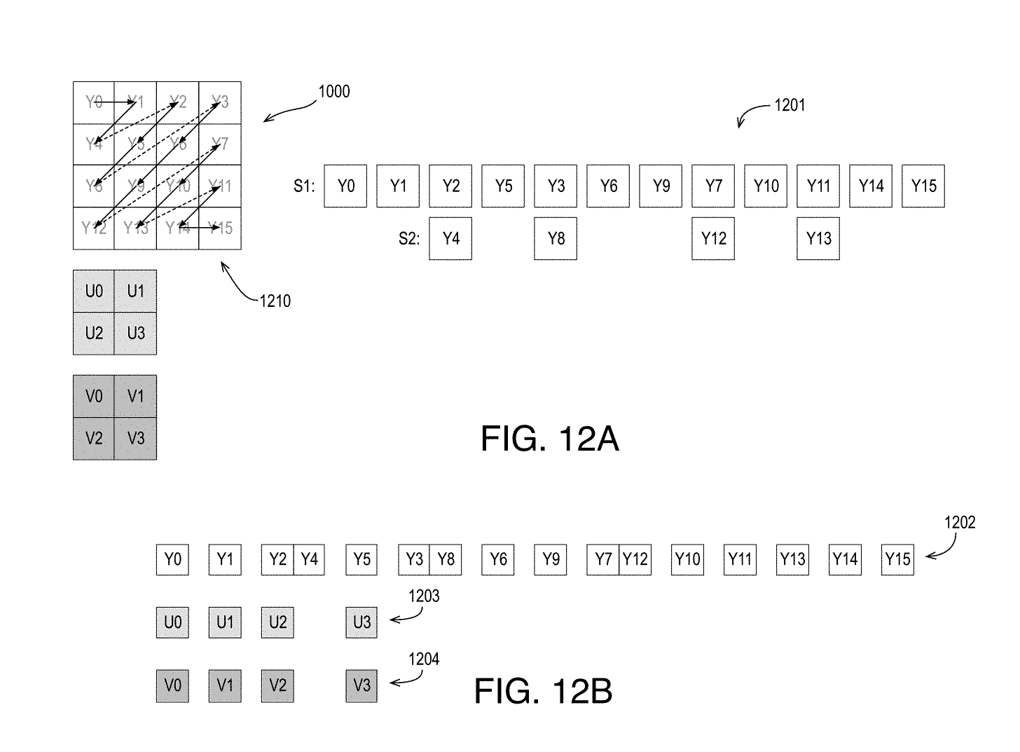

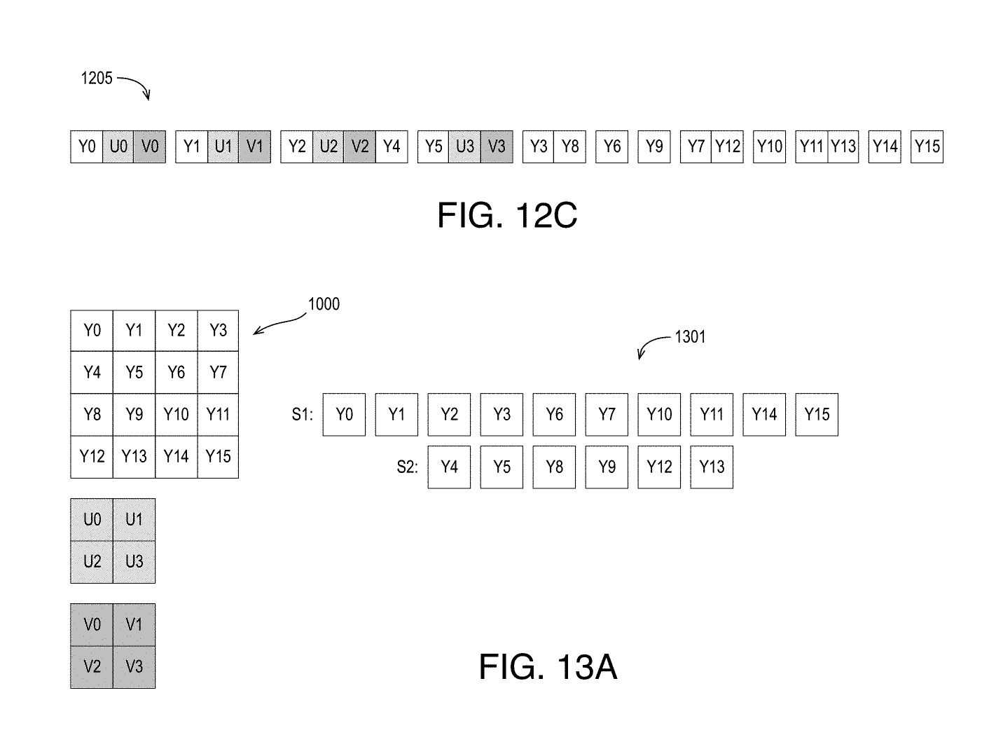

FIGS. 12A-12C illustrate an example scanning and ordering of transform units of a prediction unit to provide a coding order, arranged in accordance with at least some implementations of the present disclosure. For example, the processing order as provided by FIGS. 12A-12C may be compatible with intra prediction modes that use top right samples. As shown in FIG. 12A, example prediction unit 1000 may include 16 transform units (Y0-Y15), four chroma channel one transform units (U0-U4), and four chroma channel two transform units (V0-V4). The illustrated example may provide transform units for a 4:2:0 color sampling. The illustrated transform units may have any suitable size such as a size of 4×4 pixel samples or transform coefficients. Furthermore, as discussed herein, the illustrated transform units may have a normative coding order or standards based coding order or the like in the following order: Y0-Y15, U0-U4, V0-V4.

Also as shown in FIG. 12A, luma transform units of prediction unit 1000 may be scanned in a modified wave-front order to provide a propagation order 1201. For example, luma transform units of prediction unit 1000 may be scanned in a wave-front order modified to include dependencies for top-right samples as illustrated by dependencies 1210. Dependencies 1210 are illustrated by arrows within prediction unit 1000 such that solid arrows of dependencies 1210 indicate transform unit dependencies and dashed lines indicate independent transform units (e.g., those without dependencies). For example, luma transform units of prediction unit 1000 may be scanned in the following order. The scan may begin from an upper-left transform unit (Y0) and move to the right in a wave-front manner to the right until a dependency is hit (i.e., Y5 depending from Y2, then the dependency is followed (to provide Y5 in the scan). The scan then returns to the wave-front order at Y3, follows the dependency to Y6 and Y9, returns to the wave-front scan at Y7, follows the dependency to Y10, returns to the wave-front scan at Y11, follows the dependency to Y14, and returns to the wave-front scan at Y15.A second modified wave-front scan is then performed beginning at Y4, going to the next available transform units, in order: Y8, Y12, Y13. For example, the first modified wave-front scan attains the following luma transform units in order: Y0, Y1, Y2, Y5, Y3, Y6, Y9, Y7, Y10, Y11, Y14, Y15 as shown in Scan 1 (51) of propagation order 1201. The second modified wave-front scan attains the following luma transform units in order: Y4, Y8, Y12, Y13 as shown in Scan 2 (S2). Furthermore, the luma transform units of S2 are aligned with those of S1 such that luma transform units of S2 are provided as early as possible with the limitation that they cannot violated dependencies 1210. For example, luma transform unit Y4 is dependent on Y0 and Y1 but can be processed at the same time as Y2 since there is no dependency therebetween. Similarly, luma transform unit Y8 must be processed after Y5 but can be processed at the same time as Y3, luma transform unit Y12 must be processed after Y9 but can be processed at the same time as Y7, and luma transform unit Y13 must be processed after Y10 but can be processed at the same time as Y3.

As shown in FIG. 12B, luma transform units of prediction unit 1000 in propagation order 1201 may then be translated to a luma processing order 1202 such that luma processing order 1202 provides a time order for processing as discussed herein with provided time gaps to fulfill neighbor dependencies. For example, luma processing order 1202 may be generated from propagation order 1201 by scanning propagation order 1201 starting from a left of propagation order 1201 and scanning each column vertically from top to bottom, moving from left to right to the next column (along a row), scanning the column vertically, and so on. For example, the first column scan may provide luma transform unit Y0, the second column scan may provide luma transform unit Y1, the third column scan may provide luma transform units Y2, Y4, and so on as shown in luma processing order 1202. Such modified wave-front scanning followed by column wise scanning of the luma transform units may provide for an ordering that does not violate dependencies between luma transform units based on intra prediction modes that use top right samples. Also as shown in FIG. 12B, chroma channel one transform units may be provided in an chroma channel one transform unit order 1203 matching the normative coding order. Similarly, chroma channel two transform units may be provided in an chroma channel two transform unit order 1204 matching the normative coding order.

Turning now to FIG. 12C, a processing order 1205 for the transform units of prediction unit 1000 is provided based on the techniques discussed with respect to processing orders 802, 902. For example, processing order 1205 may be formed by packing as many groups of a luma transform unit, a chroma channel one transform unit, and a chroma channel two transform unit as available (e.g., until any of such transform units are exhausted), and then packing any available luma transform units. In the discussed context, such ordering may provide for processing order 1205 as follows: Y0, U0, V0, Y1, U1, V1, Y2, U2, V2, Y4, Y5, U3, V3, Y3, Y8, Y6, Y9, Y7, Y12, Y10, Y11, Y13, Y14, Y15. As discussed with respect to FIG. 10C, processing order 1205 may be translated to or from a normative coding order 1006 (Y0-Y15, U0-U3, V0-V3) such that intra processing may be performed with less idle time. Such processing order 1205 may be used at either or both of an encoder and a decoder based on implementation of a coding buffer.

In another embodiment, a coding order may be generated based on the techniques discussed with respect to processing orders 803, 903. For example, a processing order may be formed from orders 1202, 1203, 1204 by packing as many groups of a luma transform unit, a chroma channel one transform unit, a luma transform unit, and a chroma channel two transform unit as available (e.g., until any of such transform units are exhausted), and then packing any available luma transform units or any available chroma transform units. In the discussed context, such ordering may provide for a coding order as follows: Y0, U0, Y1, VO, Y2, U1, Y4, V1, Y5, U2, Y3, V2, Y8, U3, Y6, V3, Y6, Y9, Y7, Y12, Y10, Y11, Y13, Y14, Y15.

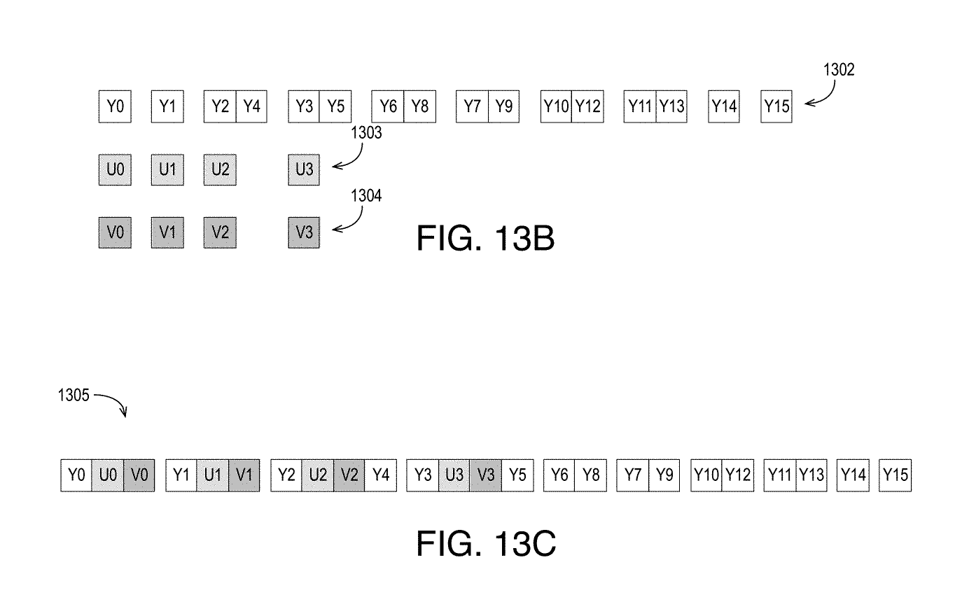

FIGS. 13A-13C illustrate an example scanning and ordering of transform units of a prediction unit to provide a coding order, arranged in accordance with at least some implementations of the present disclosure. For example, the processing order as provided by FIGS. 13A-13C may be compatible with intra prediction modes that do not use top right samples and may provide a further optimized processing order by minimizing gaps and maximizing processing compaction. As shown in FIG. 13A, example prediction unit 1000 may include 16 transform units (Y0-Y15), four chroma channel one transform units (U0-U4), and four chroma channel two transform units (V0-V4). The illustrated example may provide transform units for a 4:2:0 color sampling. The illustrated transform units may have any suitable size such as a size of 4×4 pixel samples or transform coefficients. Furthermore, as discussed herein, the illustrated transform units may have a normative coding order or standards based coding order or the like in the following order: Y0-Y15, U0-U4, V0-V4.

Also as shown in FIG. 13A, luma transform units of prediction unit 1000 may be scanned in a modified wave-front order to provide a propagation order 1201. For example, luma transform units of prediction unit 1000 may be scanned in a wave-front order modified to increase efficiency. For example, luma transform units of prediction unit 1000 may be scanned in the following order. The scan may begin from an upper-left transform unit (Y0) and move to the right in a wave-front manner to the right through an upper-right transform unit (Y3), and then may move down-diagonally to the left to improve efficiency to transform unit Y6, then right and down-left repeatedly. A second scan may then be performed that begins at the top-left available transform unit (Y4) and repeatedly moves right and down-left until all transform units are scanned. For example, the first scan attains the following luma transform units in order: Y0, Y1, Y2, Y3, Y6, Y7, Y10, Y11, Y14, as shown in Scan 1 (S1) of propagation order 1301. The second scan attains the following luma transform units in order: Y4, Y5, Y8, Y9, Y12, Y13 as shown in Scan 2 (S2).

As shown in FIG. 13B, luma transform units of prediction unit 1000 in propagation order 1201 may then be translated to a luma processing order 1302 such that luma processing order 1302 provides a time order for processing as discussed herein with provided time gaps to fulfill neighbor dependencies. For example, luma processing order 1302 may be generated from propagation order 1301 by scanning propagation order 1301 starting from a left of propagation order 1301 and scanning each column vertically from top to bottom, moving from left to right to the next column (along a row), scanning the column vertically, and so on. For example, the first column scan may provide luma transform unit Y0, the second column scan may provide luma transform unit Y1, the third column scan may provide luma transform units Y2, Y4, and so on as shown in luma processing order 1302. Such modified wave-front scanning followed by column wise scanning of the luma transform units may provide for an ordering that is efficient with respect to maximizing processing compaction. Also as shown in FIG. 13B, chroma channel one transform units may be provided in an chroma channel one transform unit order 1303 matching the normative coding order. Similarly, chroma channel two transform units may be provided in an chroma channel two transform unit order 1304 matching the normative coding order.

Turning now to FIG. 13C, a processing order 1305 for the transform units of prediction unit 1000 is provided based on the techniques discussed with respect to processing orders 802, 902. For example, processing order 1305 may be formed by packing as many groups of a luma transform unit, a chroma channel one transform unit, and a chroma channel two transform unit as available (e.g., until any of such transform units are exhausted), and then packing any available luma transform units. In the discussed context, such ordering may provide for processing order 1205 as follows: Y0, U0, V0, Y1, U1, V1, Y2, Y4, Y3, U3, V3, Y5, Y6, Y8, Y7, Y9, Y10, Y12, Y11, Y13, Y14, Y15. As discussed elsewhere herein, processing order 1305 may be translated to or from a normative coding order 1006 (Y0-Y15, U0-U3, V0-V3) such that intra processing may be performed with less idle time. Such processing order 1205 may be used at either or both of an encoder and a decoder based on implementation of a coding buffer.

In another embodiment, a coding order may be generated based on the techniques discussed with respect to processing orders 803, 903. For example, a processing order may be formed from orders 1302, 1303, 1304 by packing as many groups of a luma transform unit, a chroma channel one transform unit, a luma transform unit, and a chroma channel two transform unit as available (e.g., until any of such transform units are exhausted), and then packing any available luma transform units or any available chroma transform units. In the discussed context, such ordering may provide for a coding order as follows: Y0, U0, Y1, V0, Y2, U1, Y4, V1, Y3, U2, Y5, V2, Y6, U3, Y8, V3, Y5, U2, Y3, Y5, Y6, Y8, Y7, Y9, Y10, Y12, Y11, Y13, Y14, Y15.

The discussed systems and interleaving techniques discussed herein may provide for improved processing at an encoder and/or decoder while generating or operating on standards compliant bitstreams.

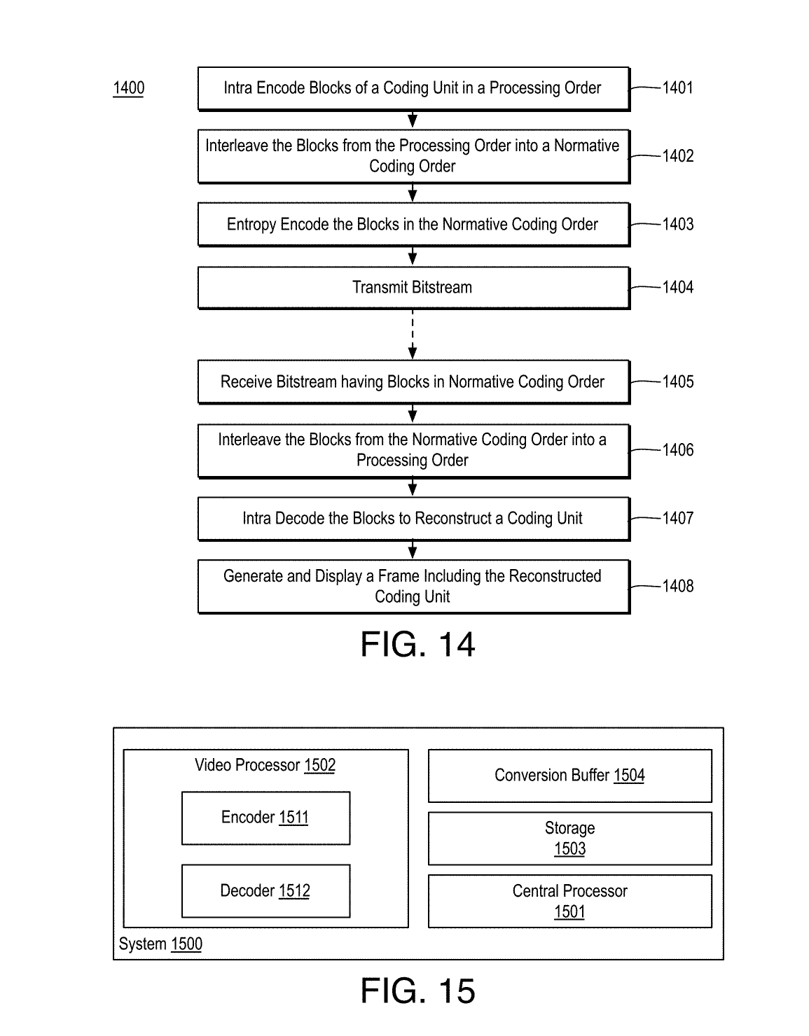

FIG. 14 is a flow diagram illustrating an example process 1400 for video coding including interleaving transform blocks by color into a processing order, arranged in accordance with at least some implementations of the present disclosure. Process 1400 may include one or more operations 1401-1408 as illustrated in FIG. 14. Process 1400 may form at least part of a video coding process. By way of non-limiting example, process 1400 may form at least part of a video coding process as performed by any device or system as discussed herein such as encoder 400 and/or encoder 600. Furthermore, process 1400 will be described herein with reference to system 1500 of FIG. 15. In some embodiments, operations 1401-1404 may be performed by an encoder and operations 1405-1408 may be performed by a decoder separate from the encoder.

FIG. 15 is an illustrative diagram of an example system 1500 for video coding including interleaving transform blocks by color into a processing order, arranged in accordance with at least some implementations of the present disclosure. As shown in FIG. 15, system 1500 may include central processor 1501, a video processor 1502, a storage 1503 (e.g., electronic storage, computer storage, computer memory, or the like), and a conversion buffer 1504. Also as shown, video processor 1502 may include or implement an encoder 1511 and/or a decoder 1512. In the example of system 1500, storage 1503 may store video data or related content such as input video, video data, video sequences, pictures, picture data, pixel samples, transform coefficients, bitstream data, and/or any other data as discussed herein.

As shown, in some examples, encoder 1511 and/or a decoder 1512 may be implemented via video processor 1502. In other examples, one or more or portions of encoder 1511 and/or a decoder 1512 may be implemented via central processor 1501 or another processing unit such as an image processor, a graphics processor, or the like. Furthermore, in some embodiments, system 1500 may include only encoder 1511 and may be characterized as an encoder system. In other embodiments, system 1500 may include only encoder 1512 and may be characterized as an encoder system. Encoder 1511 may include any suitable features such as those of encoder 400 and/or any other encoder components such as motion estimation and compensation modules, in loop filtering modules, and the like. Similarly, decoder 1512 may include any suitable features such as those of decoder 600 and/or any other encoder components such as motion estimation and compensation modules, in loop filtering modules, and the like.

Conversion buffer 1504 may include any suitable memory or storage such as volatile or non-volatile memory resources. For example, conversion buffer 1504 may provide for encoder conversion buffer 405 in conjunction with encoder 1511 and/or for decoder conversion buffer 605 in conjunction with decoder 1512. As with encoder 1511 and decoder 1512, conversion buffer 1504 may implement a decoder conversion buffer and/or an encoder conversion buffer. As illustrated, conversion buffer may be provided separately from video processor 1502 (e.g., on a separate chip). In other embodiments, conversion buffer 1504 may be provided on the same chip as video processor 1502 (e.g., as a system on a chip package or as on board memory of video processor).

Video processor 1502 may include any number and type of video, image, or graphics processing units that may provide the operations as discussed herein. Such operations may be implemented via software or hardware or a combination thereof. For example, video processor 1502 may include circuitry dedicated to manipulate video, pictures, picture data, or the like obtained from storage 1503. Central processor 1501 may include any number and type of processing units or modules that may provide control and other high level functions for system 1500 and/or provide any operations as discussed herein. Storage 1503 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, storage 1503 may be implemented by cache memory. Conversion buffer 1504 may be implemented separately from storage 1503 (as shown) or as a portion of storage 1503.

In an embodiment, one or more or portions of encoder 1511 and/or a decoder 1512 may be implemented via an execution unit (EU). The EU may include, for example, programmable logic or circuitry such as a logic core or cores that may provide a wide array of programmable logic functions. In an embodiment, one or more or portions of encoder 1511 and/or a decoder 1512 may be implemented via dedicated hardware such as fixed function circuitry or the like. Fixed function circuitry may include dedicated logic or circuitry and may provide a set of fixed function entry points that may map to the dedicated logic for a fixed purpose or function.

Returning to discussion of FIG. 14, process 1400 may begin at operation 1401, where a plurality of blocks corresponding to a coding unit of a video frame may be encoded in a processing order to generate a corresponding plurality of blocks of quantized residual transform coefficients. The processing order implemented at operation 1401 may include any processing order as discussed herein. In an embodiment, encode tasks such as mode selection or the like may made and the blocks (e.g., transform blocks or units) may be interleaved as discussed herein prior to intra processing. In an embodiment, such encode tasks may be performed in the processing order. The encoding of the blocks in the processing order may include any suitable technique or techniques. For example, the encoding may include one or more of residual generation, forward transform, forward quantization, inverse quantization, inverse transform, and intra prediction operations. In an embodiment, operation 1401 may be performed by encoder 1511 as implemented by video processor 1502.

As discussed, the processing order implemented at operation 1401 may include any processing order as discussed herein. In an embodiment, the processing order includes a first luma block followed immediately by a first chroma channel one block. For example, the first luma block may be a spatially upper-left luma transform block of the coding unit. The first chroma channel one block may be the only chroma channel one block of the coding or a spatially upper-left luma transform block of the coding unit or the like.

In an embodiment, the processing order may include the first luma block followed immediately by the first chroma channel one block followed immediately by a first chroma channel two block of the one or more chroma channel two blocks followed immediately by a second luma block of the one or more luma blocks as discussed with respect to processing order 802 and elsewhere herein. For example, the first luma block may correspond to a spatially upper left region of the coding unit and the second luma block may correspond to a second region of the coding unit immediately to the right of the upper left region.

In an embodiment, the processing order may include the first luma block followed immediately by the first chroma channel one block followed immediately by a second luma block of the one or more luma blocks followed immediately by a first chroma channel two block of the one or more chroma channel two blocks followed immediately by a third luma block of the one or more luma blocks as discussed with respect to processing order 803 and elsewhere herein. For example, the first luma block may correspond to a spatially upper left region of the coding unit, the second luma block may correspond to a second region of the coding unit immediately to the right of the upper left region, and the third luma block may correspond to a third region of the coding unit immediately below the upper left region.

In an embodiment, the processing order may include a plurality of contiguous groups consisting of a first single luma block immediately followed by a single chroma channel one block immediately followed by a second single luma block immediately followed by a single chroma channel two block and a subsequent contiguous group of remaining luma blocks as discussed with respect to processing order 803 and elsewhere herein. In an embodiment, the processing order comprises a plurality of contiguous groups consisting of a single luma block immediately followed by a single chroma channel one block immediately followed by a chroma channel two block and a subsequent contiguous group of remaining luma blocks as discussed with respect to processing order 802 and elsewhere herein.

In an embodiment, the processing order may include luma blocks, the chroma channel one blocks, and the chroma channel two blocks each ordered based on multiple spatially down-left oriented scans with a first of the multiple down-left oriented scans beginning at a top-left block of the coding unit and each subsequent down-left oriented scan beginning at a block to the right of each previous down-left oriented scan as discussed with respect to processing order 1005 and elsewhere herein. In an embodiment, the processing order may include luma blocks ordered based on a spatial scanning of the luma blocks such that the spatial scanning includes a first block at a top-left luma block of the coding unit, a second block immediately to the right of the first block, a third block immediately below the first block, a fourth block immediately to the right of the second block, and a fifth block immediately to the right of the third block as discussed with respect to processing orders 1005, 1105 and elsewhere herein.

In an embodiment, the processing order may include luma blocks ordered based on a spatial scanning of the luma blocks, the spatial scanning including a first block at a top-left luma block of the coding unit, a second block immediately to the right of the first block, a third block immediately to the right of the second block, a fourth block immediately below the first block, and a fifth block immediately to the right of the fourth block as discussed with respect to processing order 1205 and elsewhere herein.

Processing may continue at operation 1402, where the blocks may be interleaved from the processing order discussed with respect to operation 1401 to a normative coding order. For example, the normative coding order may be any standards based coding order or the like. In an embodiment, transform blocks (e.g., quantized residual quantized coefficients) may be stored to conversion buffer 1504 from video processor 1502 in the processing order and retrieved from conversion buffer 1504 to video processor 1502 in the normative coding order for further processing.

Processing may continue at operation 1403, where the blocks may be entropy encoded in the normative coding order. In an embodiment, the transform blocks (e.g., quantized residual quantized coefficients) may be entropy encoded by encoder 1511 in the normative coding order to generate a standards (e.g., AVC, HEVC, AV1, VP9, or the like) compliant bitstream. The entropy encoding may be performed using any suitable technique or techniques such as samples-to-bin/bit processing or the like.

Processing may continue at operation 1404, where the bitstream generated at operation 1403 may be stored, transmitted, or the like. In an embodiment, the bitstream may be stored to storage 1503. In an embodiment, the bitstream may be transmitted to a remote storage, a remote decoder device or system, multiple remote decoder devices or systems, or the like.

As discussed, in some embodiments, operations 1401-1404 may be performed by an encoder device or system separate from a decoder device or system that performs operations 1405-1408.

Processing may continue at the same or a separate device at operation 1405, where a bitstream may be received for processing. The bitstream may be the same bitstream as discussed with respect to operation 1404 or it may be a different bitstream generated using the discussed techniques or not. In any event, the bitstream received at operation 1405 may be a standards (e.g., AVC, HEVC, AV1, VP9, or the like) compliant bitstream having blocks in a normative coding order. For example, the blocks may be blocks of quantized residual transform coefficients corresponding to a coding unit of a video frame in a normative coding order. In an embodiment, the normative coding order includes two or more immediately adjacent luma blocks followed by one or more chroma channel one blocks followed by one or more chroma channel two blocks. For example, the blocks may be ordered based on a raster scan of the luma blocks, followed by a raster scan of the chroma channel one blocks, followed by a raster scan of the chroma channel two blocks.

Processing may continue at operation 1406, where the blocks may be interleaved or translated from the normative coding order into a processing order. As discussed, the blocks may include blocks of quantized residual transform coefficients corresponding to a coding unit of a video frame. The processing order may include any processing order discussed herein. In an embodiment, the processing order includes at least a first luma block of the two or more luma blocks followed immediately by a first chroma channel one block of the one or more chroma channel one blocks. In an embodiment, transform blocks (e.g., quantized residual quantized coefficients) may be stored to conversion buffer 1504 from video processor 1502 in the normative coding order and retrieved from conversion buffer 1504 to video processor 1502 in the processing order for further processing.

As discussed, the processing order implemented at operation 1406 may include any processing order as discussed herein. In an embodiment, the processing order may include the first luma block followed immediately by the first chroma channel one block followed immediately by a first chroma channel two block of the one or more chroma channel two blocks followed immediately by a second luma block of the two or more luma blocks as discussed with respect to processing order 802 and elsewhere herein. For example, the first luma block may correspond to a spatially upper left region of the coding unit and the second luma block may correspond to a second region of the coding unit immediately to the right of the upper left region.

In an embodiment, the processing order may include the first luma block followed immediately by the first chroma channel one block followed immediately by a second luma block of the two or more luma blocks followed immediately by a first chroma channel two block of the one or more chroma channel two blocks followed immediately by a third luma block of the two or more luma blocks as discussed with respect to processing order 803 and elsewhere herein. For example, the first luma block corresponds to a spatially upper left region of the coding unit, the second luma block corresponds to a second region of the coding unit immediately to the right of the upper left region, and the third luma block corresponds to a third region of the coding unit immediately below the upper left region.

In an embodiment, interleaving the blocks may include providing contiguous groups consisting of a first single luma block immediately followed by a single chroma channel one block immediately followed by a second single luma block immediately followed by a single chroma channel two block until the chroma channel one blocks and chroma channel two blocks are exhausted and subsequently providing a contiguous group of remaining luma blocks as discussed with respect to processing order 802 and elsewhere herein. In an embodiment, interleaving the blocks may include providing one or more contiguous groups consisting of a single luma block immediately followed by a single chroma channel one block immediately followed by a chroma channel two block until the chroma channel one blocks and chroma channel two blocks are exhausted and subsequently providing a contiguous group of remaining luma blocks as discussed with respect to processing order 803 and elsewhere herein.

In an embodiment, the processing order comprises the luma blocks scanned spatially in a spatial wave-front order with respect to the coding unit and ordered based on neighboring dependencies among the luma blocks as discussed with respect to processing order 1205 and elsewhere herein. In an embodiment, the processing order may include the luma blocks, the chroma channel one blocks, and the chroma channel two blocks each ordered based on multiple spatially down-left oriented scans with a first of the multiple down-left oriented scans beginning at a top-left block of the coding unit and each subsequent down-left oriented scan beginning at a block to the right of each previous down-left oriented scan as discussed with respect to processing order 1005 and elsewhere herein.

In an embodiment, the processing order may include the luma blocks ordered based on a spatial scanning of the luma blocks, the spatial scanning including a first block at a top-left luma block of the coding unit, a second block immediately to the right of the first block, a third block immediately below the first block, a fourth block immediately to the right of the second block, and a fifth block immediately to the right of the third block as discussed with respect to processing order 1005, 1105 and elsewhere herein.

In an embodiment, the processing order comprises the luma blocks ordered based on a spatial scanning of the luma blocks, the spatial scanning including a first block at a top-left luma block of the coding unit, a second block immediately to the right of the first block, a third block immediately to the right of the second block, a fourth block immediately below the first block, and a fifth block immediately to the right of the fourth block as discussed with respect to processing order 1205 and elsewhere herein.

Processing may continue at operation 1407, where intra decoding may be performed on the blocks in the processing order to generate a reconstructed coding unit including the reconstructed blocks. In an embodiment, the intra decoding includes performing inverse quantization, inverse transform, and intra prediction operations on the blocks (e.g., blocks of quantized coefficients) in the processing order to generate a reconstructed coding unit corresponding to the plurality of blocks of quantized residual transform coefficients.

Processing may continue at operation 1408, where the reconstructed coding unit as discussed with respect to operation 1407 may be used to generate a reconstructed frame, which may be displayed to a user, stored to memory, or the like. The frame reconstruction may be performed using any suitable technique or techniques. For example, operations 1405-1407 may be performed for multiple coding units and such coding units, as well as inter predicted coding units, and the like may be combined to reconstruct a frame or frames of a video sequence. The video sequence may be stored and/or transmitted to a display for presentment to a user.

Process 1400, or portions thereof, may be repeated any number of times either in series or in parallel for any number video sequences, video frames, coding units, or the like. As discussed, process 1400 may provide for video coding including interleaving transform blocks by color into a processing order and processing in the processing order (at the encoder and/or decoder side). For example, the discussed techniques for video coding may provide increased efficiency and throughput for intra coding operations.

Various components of the systems described herein may be implemented in software, firmware, and/or hardware and/or any combination thereof. For example, various components of the systems or devices discussed herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

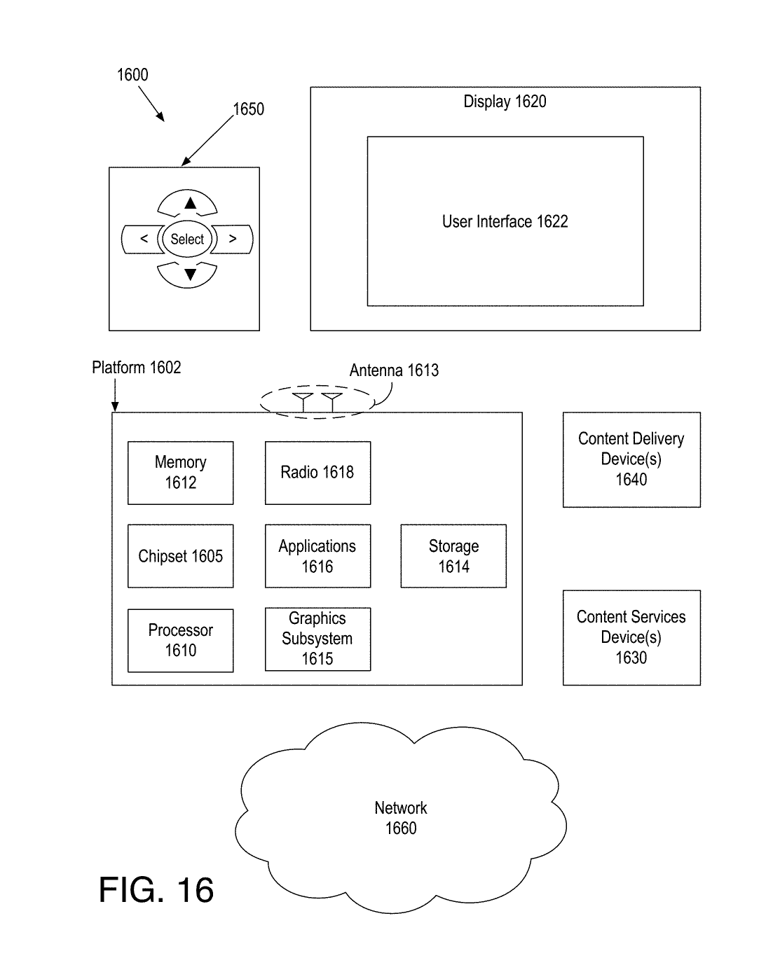

FIG. 16 is an illustrative diagram of an example system 1600, arranged in accordance with at least some implementations of the present disclosure. In various implementations, system 1600 may be a mobile system although system 1600 is not limited to this context. For example, system 1600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1600 includes a platform 1602 coupled to a display 1620. Platform 1602 may receive content from a content device such as content services device(s) 1630 or content delivery device(s) 1640 or other similar content sources. A navigation controller 1650 including one or more navigation features may be used to interact with, for example, platform 1602 and/or display 1620. Each of these components is described in greater detail below.

In various implementations, platform 1602 may include any combination of a chipset 1605, processor 1610, memory 1612, antenna 1613, storage 1614, graphics subsystem 1615, applications 1616 and/or radio 1618. Chipset 1605 may provide intercommunication among processor 1610, memory 1612, storage 1614, graphics subsystem 1615, applications 1616 and/or radio 1618. For example, chipset 1605 may include a storage adapter (not depicted) capable of providing intercommunication with storage 1614.

Processor 1610 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1610 may be dual-core processor(s), dual-core mobile processor(s), and so forth.

Memory 1612 may be implemented as a volatile memory device such as, but not limited to, a Random Access Memory (RAM), Dynamic Random Access Memory (DRAM), or Static RAM (SRAM).

Storage 1614 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1614 may include technology to increase the storage performance enhanced protection for valuable digital media when multiple hard drives are included, for example.

Graphics subsystem 1615 may perform processing of images such as still or video for display. Graphics subsystem 1615 may be a graphics processing unit (GPU) or a visual processing unit (VPU), for example. An analog or digital interface may be used to communicatively couple graphics subsystem 1615 and display 1620. For example, the interface may be any of a High-Definition Multimedia Interface, DisplayPort, wireless HDMI, and/or wireless HD compliant techniques. Graphics subsystem 1615 may be integrated into processor 1610 or chipset 1605. In some implementations, graphics subsystem 1615 may be a stand-alone device communicatively coupled to chipset 1605.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 1618 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1618 may operate in accordance with one or more applicable standards in any version.

In various implementations, display 1620 may include any television type monitor or display. Display 1620 may include, for example, a computer display screen, touch screen display, video monitor, television-like device, and/or a television. Display 1620 may be digital and/or analog. In various implementations, display 1620 may be a holographic display. Also, display 1620 may be a transparent surface that may receive a visual projection. Such projections may convey various forms of information, images, and/or objects. For example, such projections may be a visual overlay for a mobile augmented reality (MAR) application. Under the control of one or more software applications 1616, platform 1602 may display user interface 1622 on display 1620.

In various implementations, content services device(s) 1630 may be hosted by any national, international and/or independent service and thus accessible to platform 1602 via the Internet, for example. Content services device(s) 1630 may be coupled to platform 1602 and/or to display 1620. Platform 1602 and/or content services device(s) 1630 may be coupled to a network 1660 to communicate (e.g., send and/or receive) media information to and from network 1660. Content delivery device(s) 1640 also may be coupled to platform 1602 and/or to display 1620.

In various implementations, content services device(s) 1630 may include a cable television box, personal computer, network, telephone, Internet enabled devices or appliance capable of delivering digital information and/or content, and any other similar device capable of uni-directionally or bi-directionally communicating content between content providers and platform 1602 and/display 1620, via network 1660 or directly. It will be appreciated that the content may be communicated uni-directionally and/or bi-directionally to and from any one of the components in system 1600 and a content provider via network 1660. Examples of content may include any media information including, for example, video, music, medical and gaming information, and so forth.

Content services device(s) 1630 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1602 may receive control signals from navigation controller 1650 having one or more navigation features. The navigation features of may be used to interact with user interface 1622, for example. In various embodiments, navigation may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of may be replicated on a display (e.g., display 1620) by movements of a pointer, cursor, focus ring, or other visual indicators displayed on the display. For example, under the control of software applications 1616, the navigation features located on navigation may be mapped to virtual navigation features displayed on user interface 1622, for example. In various embodiments, may not be a separate component but may be integrated into platform 1602 and/or display 1620. The present disclosure, however, is not limited to the elements or in the context shown or described herein.

In various implementations, drivers (not shown) may include technology to enable users to instantly turn on and off platform 1602 like a television with the touch of a button after initial boot-up, when enabled, for example. Program logic may allow platform 1602 to stream content to media adaptors or other content services device(s) 1630 or content delivery device(s) 1640 even when the platform is turned “off.” In addition, chipset 1605 may include hardware and/or software support for 5.1 surround sound audio and/or high definition 7.1 surround sound audio, for example. Drivers may include a graphics driver for integrated graphics platforms. In various embodiments, the graphics driver may include a peripheral component interconnect (PCI) Express graphics card.

In various implementations, any one or more of the components shown in system 1600 may be integrated. For example, platform 1602 and content services device(s) 1630 may be integrated, or platform 1602 and content delivery device(s) 1640 may be integrated, or platform 1602, content services device(s) 1630, and content delivery device(s) 1640 may be integrated, for example. In various embodiments, platform 1602 and display 1620 may be an integrated unit.

Display 1620 and content service device(s) 1630 may be integrated, or display 1620 and content delivery device(s) 1640 may be integrated, for example. These examples are not meant to limit the present disclosure.

In various embodiments, system 1600 may be implemented as a wireless system, a wired system, or a combination of both. When implemented as a wireless system, system 1600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1602 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 16.

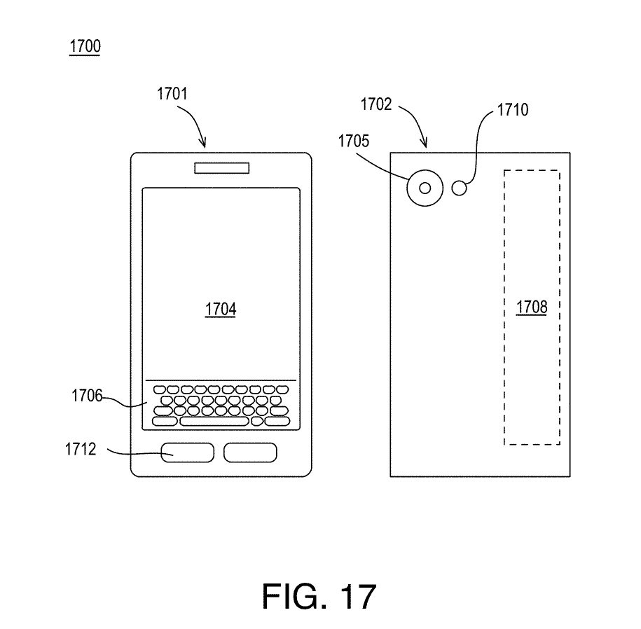

As described above, system 1600 may be embodied in varying physical styles or form factors. FIG. 17 illustrates an example small form factor device 1700, arranged in accordance with at least some implementations of the present disclosure. In some examples, system 1600 may be implemented via device 1700. In other examples, system 1500 or portions thereof may be implemented via device 1700. In various embodiments, for example, device 1700 may be implemented as a mobile computing device a having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras, and so forth.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 17, device 1700 may include a housing with a front 1701 and a back 1702. Device 1700 includes a display 1704, an input/output (I/O) device 1706, and an integrated antenna 1708. Device 1700 also may include navigation features 1712. I/O device 1706 may include any suitable I/O device for entering information into a mobile computing device. Examples for I/O device 1706 may include an alphanumeric keyboard, a numeric keypad, a touch pad, input keys, buttons, switches, microphones, speakers, voice recognition device and software, and so forth. Information also may be entered into device 1700 by way of microphone (not shown), or may be digitized by a voice recognition device. As shown, device 1700 may include a camera 1705 (e.g., including a lens, an aperture, and an imaging sensor) and a flash 1710 integrated into back 1702 (or elsewhere) of device 1700. In other examples, camera 1705 and flash 1710 may be integrated into front 1701 of device 1700 or both front and back cameras may be provided. Camera 1705 and flash 1710 may be components of a camera module to originate image data processed into streaming video that is output to display 1704 and/or communicated remotely from device 1700 via antenna 1708 for example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following embodiments pertain to further embodiments.

In one or more first embodiments, computer-implemented method for video coding comprises receiving, for coding, a plurality of blocks of quantized residual transform coefficients corresponding to a coding unit of a video frame in a normative coding order, the normative coding order comprising two or more immediately adjacent luma blocks followed by one or more chroma channel one blocks followed by one or more chroma channel two blocks, interleaving the plurality of blocks of quantized residual transform coefficients from the normative coding order into a processing order, the processing order comprising at least a first luma block of the two or more luma blocks followed immediately by a first chroma channel one block of the one or more chroma channel one blocks, and performing inverse quantization, inverse transform, and intra prediction operations on the plurality of blocks of quantized coefficients in the processing order to generate a reconstructed coding unit corresponding to the plurality of blocks of quantized residual transform coefficients.

Further to the first embodiments, the processing order comprises the first luma block followed immediately by the first chroma channel one block followed immediately by a first chroma channel two block of the one or more chroma channel two blocks followed immediately by a second luma block of the two or more luma blocks.

Further to the first embodiments, the processing order comprises the first luma block followed immediately by the first chroma channel one block followed immediately by a first chroma channel two block of the one or more chroma channel two blocks followed immediately by a second luma block of the two or more luma blocks and the first luma block corresponds to a spatially upper left region of the coding unit and the second luma block corresponds to a second region of the coding unit immediately to the right of the upper left region.

Further to the first embodiments, the processing order comprises the first luma block followed immediately by the first chroma channel one block followed immediately by a second luma block of the two or more luma blocks followed immediately by a first chroma channel two block of the one or more chroma channel two blocks followed immediately by a third luma block of the two or more luma blocks.

Further to the first embodiments, the processing order comprises the first luma block followed immediately by the first chroma channel one block followed immediately by a second luma block of the two or more luma blocks followed immediately by a first chroma channel two block of the one or more chroma channel two blocks followed immediately by a third luma block of the two or more luma blocks and the first luma block corresponds to a spatially upper left region of the coding unit, the second luma block corresponds to a second region of the coding unit immediately to the right of the upper left region, and the third luma block corresponds to a third region of the coding unit immediately below the upper left region.

Further to the first embodiments, interleaving the plurality of blocks comprises providing contiguous groups consisting of a first single luma block immediately followed by a single chroma channel one block immediately followed by a second single luma block immediately followed by a single chroma channel two block until the chroma channel one blocks and chroma channel two blocks are exhausted and subsequently providing a contiguous group of remaining luma blocks.

Further to the first embodiments, interleaving the plurality of blocks comprises providing one or more contiguous groups consisting of a single luma block immediately followed by a single chroma channel one block immediately followed by a chroma channel two block until the chroma channel one blocks and chroma channel two blocks are exhausted and subsequently providing a contiguous group of remaining luma blocks.

Further to the first embodiments, the processing order comprises the luma blocks scanned spatially in a spatial wave-front order with respect to the coding unit and ordered based on neighboring dependencies among the luma blocks.

Further to the first embodiments, the processing order comprises the luma blocks, the chroma channel one blocks, and the chroma channel two blocks each ordered based on multiple spatially down-left oriented scans with a first of the multiple down-left oriented scans beginning at a top-left block of the coding unit and each subsequent down-left oriented scan beginning at a block to the right of each previous down-left oriented scan.

Further to the first embodiments, the processing order comprises the luma blocks ordered based on a spatial scanning of the luma blocks, the spatial scanning comprising at least a first block at a top-left luma block of the coding unit, a second block immediately to the right of the first block, a third block immediately below the first block, a fourth block immediately to the right of the second block, and a fifth block immediately to the right of the third block

Further to the first embodiments, the processing order comprises the luma blocks ordered based on a spatial scanning of the luma blocks, the spatial scanning comprising at least a first block at a top-left luma block of the coding unit, a second block immediately to the right of the first block, a third block immediately to the right of the second block, a fourth block immediately below the first block, and a fifth block immediately to the right of the fourth block.

In one or more second embodiments, a system for video coding comprises a decoupling buffer to store blocks of quantized residual transform coefficients corresponding to a coding unit of a video frame and a processor coupled to the decoupling buffer, the processor to store the blocks of quantized residual transform coefficients in a normative coding order in the decoupling buffer, the normative coding order comprising two or more immediately adjacent luma blocks followed by one or more chroma channel one blocks followed by one or more chroma channel two blocks, to retrieve the blocks from the decoupling buffer into an interleaved processing order, the processing order comprising at least a first luma block of the two or more luma blocks followed immediately by a first chroma channel one block of the one or more chroma channel one blocks, and to perform inverse quantization, inverse transform, and intra prediction operations on the plurality of blocks of quantized coefficients in the processing order to generate a reconstructed coding unit corresponding to the plurality of blocks of quantized residual transform coefficients.

Further to the second embodiments, the processing order comprises the first luma block followed immediately by the first chroma channel one block followed immediately by a first chroma channel two block of the one or more chroma channel two blocks followed immediately by a second luma block of the two or more luma blocks.

Further to the second embodiments, the processing order comprises the first luma block followed immediately by the first chroma channel one block followed immediately by a first chroma channel two block of the one or more chroma channel two blocks followed immediately by a second luma block of the two or more luma blocks and the first luma block corresponds to a spatially upper left region of the coding unit and the second luma block corresponds to a second region of the coding unit immediately to the right of the upper left region.

Further to the second embodiments, the processing order comprises the first luma block followed immediately by the first chroma channel one block followed immediately by a second luma block of the two or more luma blocks followed immediately by a first chroma channel two block of the one or more chroma channel two blocks followed immediately by a third luma block of the two or more luma blocks.

Further to the second embodiments, the processing order comprises the first luma block followed immediately by the first chroma channel one block followed immediately by a second luma block of the two or more luma blocks followed immediately by a first chroma channel two block of the one or more chroma channel two blocks followed immediately by a third luma block of the two or more luma blocks and the first luma block corresponds to a spatially upper left region of the coding unit, the second luma block corresponds to a second region of the coding unit immediately to the right of the upper left region, and the third luma block corresponds to a third region of the coding unit immediately below the upper left region.

Further to the second embodiments, the processor to retrieve the blocks from the decoupling buffer into the interleaved processing order comprises the processor to retrieve contiguous groups consisting of a first single luma block immediately followed by a single chroma channel one block immediately followed by a second single luma block immediately followed by a single chroma channel two block until the chroma channel one blocks and chroma channel two blocks are exhausted and to subsequently retrieve a contiguous group of remaining luma blocks.

Further to the second embodiments, the processor to retrieve the blocks from the decoupling buffer into the interleaved processing order comprises the processor to retrieve one or more contiguous groups consisting of a single luma block immediately followed by a single chroma channel one block immediately followed by a chroma channel two block until the chroma channel one blocks and chroma channel two blocks are exhausted and to subsequently retrieve a contiguous group of remaining luma blocks.

Further to the second embodiments, the processing order comprises the luma blocks scanned spatially in a spatial wave-front order with respect to the coding unit and ordered based on neighboring dependencies among the luma blocks.

Further to the second embodiments, the processing order comprises the luma blocks, the chroma channel one blocks, and the chroma channel two blocks each ordered based on multiple spatially down-left oriented scans with a first of the multiple down-left oriented scans beginning at a top-left block of the coding unit and each subsequent down-left oriented scan beginning at a block to the right of each previous down-left oriented scan.

Further to the second embodiments, the processing order comprises the luma blocks ordered based on a spatial scanning of the luma blocks, the spatial scanning comprising at least a first block at a top-left luma block of the coding unit, a second block immediately to the right of the first block, a third block immediately below the first block, a fourth block immediately to the right of the second block, and a fifth block immediately to the right of the third block.

Further to the second embodiments, the processing order comprises the luma blocks ordered based on a spatial scanning of the luma blocks, the spatial scanning comprising at least a first block at a top-left luma block of the coding unit, a second block immediately to the right of the first block, a third block immediately to the right of the second block, a fourth block immediately below the first block, and a fifth block immediately to the right of the fourth block.

In one or more third embodiments, a computer-implemented method for video coding comprises encoding a plurality of blocks corresponding to a coding unit of a video frame in a processing order to generate a corresponding plurality of blocks of quantized residual transform coefficients, wherein the encoding comprises at least inverse quantization, inverse transform, and intra prediction operations, and wherein the processing order comprising at least a first luma block followed immediately by a first chroma channel one block, interleaving the plurality of blocks of quantized residual transform coefficients from the processing order into a normative coding order, the normative coding order comprising the first luma block followed immediately by one or more immediately adjacent luma blocks followed by the first chroma channel one block followed by one or more chroma channel two blocks, and entropy encoding the plurality of blocks of quantized residual transform coefficients in the normative coding order to generate a bitstream.

Further to the third embodiments, the processing order comprises the first luma block followed immediately by the first chroma channel one block followed immediately by a first chroma channel two block of the one or more chroma channel two blocks followed immediately by a second luma block of the one or more luma blocks, and wherein the first luma block corresponds to a spatially upper left region of the coding unit and the second luma block corresponds to a second region of the coding unit immediately to the right of the upper left region.

Further to the third embodiments, the processing order comprises the first luma block followed immediately by the first chroma channel one block followed immediately by a second luma block of the one or more luma blocks followed immediately by a first chroma channel two block of the one or more chroma channel two blocks followed immediately by a third luma block of the one or more luma blocks, and wherein the first luma block corresponds to a spatially upper left region of the coding unit, the second luma block corresponds to a second region of the coding unit immediately to the right of the upper left region, and the third luma block corresponds to a third region of the coding unit immediately below the upper left region.

Further to the third embodiments, the processing order comprises a plurality of contiguous groups consisting of a first single luma block immediately followed by a single chroma channel one block immediately followed by a second single luma block immediately followed by a single chroma channel two block and a subsequent contiguous group of remaining luma blocks.

Further to the third embodiments, the processing order comprises a plurality of contiguous groups consisting of a single luma block immediately followed by a single chroma channel one block immediately followed by a chroma channel two block and a subsequent contiguous group of remaining luma blocks.

Further to the third embodiments, the processing order comprises luma blocks, the chroma channel one blocks, and the chroma channel two blocks each ordered based on multiple spatially down-left oriented scans with a first of the multiple down-left oriented scans beginning at a top-left block of the coding unit and each subsequent down-left oriented scan beginning at a block to the right of each previous down-left oriented scan.

Further to the third embodiments, the processing order comprises luma blocks ordered based on a spatial scanning of the luma blocks, the spatial scanning comprising at least a first block at a top-left luma block of the coding unit, a second block immediately to the right of the first block, a third block immediately below the first block, a fourth block immediately to the right of the second block, and a fifth block immediately to the right of the third block.

Further to the third embodiments, the processing order comprises luma blocks ordered based on a spatial scanning of the luma blocks, the spatial scanning comprising at least a first block at a top-left luma block of the coding unit, a second block immediately to the right of the first block, a third block immediately to the right of the second block, a fourth block immediately below the first block, and a fifth block immediately to the right of the fourth block.

In one or more fourth embodiments, a system for video coding comprises a decoupling buffer to store a plurality of blocks corresponding to a coding unit of a video frame in a processing order and a processor coupled to the decoupling buffer, the processor to encode the plurality of blocks in the processing order to generate a corresponding plurality of blocks of quantized residual transform coefficients, wherein the encoding comprises at least inverse quantization, inverse transform, and intra prediction operations, and wherein the processing order comprising at least a first luma block followed immediately by a first chroma channel one block, to interleave the plurality of blocks of quantized residual transform coefficients from the processing order into a normative coding order, the normative coding order comprising the first luma block followed immediately by one or more immediately adjacent luma blocks followed by the first chroma channel one block followed by one or more chroma channel two blocks, and to entropy encode the plurality of blocks of quantized residual transform coefficients in the normative coding order to generate a bitstream.

Further to the fourth embodiments, the processing order comprises the first luma block followed immediately by the first chroma channel one block followed immediately by a first chroma channel two block of the one or more chroma channel two blocks followed immediately by a second luma block of the one or more luma blocks, and wherein the first luma block corresponds to a spatially upper left region of the coding unit and the second luma block corresponds to a second region of the coding unit immediately to the right of the upper left region.

Further to the fourth embodiments, the processing order comprises the first luma block followed immediately by the first chroma channel one block followed immediately by a second luma block of the one or more luma blocks followed immediately by a first chroma channel two block of the one or more chroma channel two blocks followed immediately by a third luma block of the one or more luma blocks, and wherein the first luma block corresponds to a spatially upper left region of the coding unit, the second luma block corresponds to a second region of the coding unit immediately to the right of the upper left region, and the third luma block corresponds to a third region of the coding unit immediately below the upper left region.

Further to the fourth embodiments, the processing order comprises a plurality of contiguous groups consisting of a first single luma block immediately followed by a single chroma channel one block immediately followed by a second single luma block immediately followed by a single chroma channel two block and a subsequent contiguous group of remaining luma blocks.

Further to the fourth embodiments, the processing order comprises a plurality of contiguous groups consisting of a single luma block immediately followed by a single chroma channel one block immediately followed by a chroma channel two block and a subsequent contiguous group of remaining luma blocks.

Further to the fourth embodiments, the processing order comprises luma blocks, the chroma channel one blocks, and the chroma channel two blocks each ordered based on multiple spatially down-left oriented scans with a first of the multiple down-left oriented scans beginning at a top-left block of the coding unit and each subsequent down-left oriented scan beginning at a block to the right of each previous down-left oriented scan.

Further to the fourth embodiments, the processing order comprises luma blocks ordered based on a spatial scanning of the luma blocks, the spatial scanning comprising at least a first block at a top-left luma block of the coding unit, a second block immediately to the right of the first block, a third block immediately below the first block, a fourth block immediately to the right of the second block, and a fifth block immediately to the right of the third block.

Further to the fourth embodiments, the processing order comprises luma blocks ordered based on a spatial scanning of the luma blocks, the spatial scanning comprising at least a first block at a top-left luma block of the coding unit, a second block immediately to the right of the first block, a third block immediately to the right of the second block, a fourth block immediately below the first block, and a fifth block immediately to the right of the fourth block.

In one or more fifth embodiments, at least one machine readable medium may include a plurality of instructions that in response to being executed on a computing device, causes the computing device to perform a method according to any one of the above embodiments.

In one or more sixth embodiments, an apparatus or system may include means for performing a method according to any one of the above embodiments.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. A computer-implemented method for video coding comprising:
receiving, for coding, a plurality of blocks of quantized residual transform coefficients corresponding to a coding unit of a video frame in a normative coding order, the normative coding order comprising two or more immediately adjacent luma blocks followed by one or more chroma channel one blocks followed by one or more chroma channel two blocks;
interleaving the plurality of blocks of quantized residual transform coefficients from the normative coding order into a processing order, the processing order comprising at least a first luma block of the two or more luma blocks followed immediately by a first chroma channel one block of the one or more chroma channel one blocks; and
performing inverse quantization, inverse transform, and intra prediction operations on the plurality of blocks of quantized coefficients in the processing order to generate a reconstructed coding unit corresponding to the plurality of blocks of quantized residual transform coefficients.

2. The method of claim 1, wherein the processing order comprises the first luma block followed immediately by the first chroma channel one block followed immediately by a first chroma channel two block of the one or more chroma channel two blocks followed immediately by a second luma block of the two or more luma blocks.

3. The method of claim 2, wherein the first luma block corresponds to a spatially upper left region of the coding unit and the second luma block corresponds to a second region of the coding unit immediately to the right of the upper left region.

4. The method of claim 1, wherein the processing order comprises the first luma block followed immediately by the first chroma channel one block followed immediately by a second luma block of the two or more luma blocks followed immediately by a first chroma channel two block of the one or more chroma channel two blocks followed immediately by a third luma block of the two or more luma blocks.

5. The method of claim 4, wherein the first luma block corresponds to a spatially upper left region of the coding unit, the second luma block corresponds to a second region of the coding unit immediately to the right of the upper left region, and the third luma block corresponds to a third region of the coding unit immediately below the upper left region.

6. The method of claim 1, wherein interleaving the plurality of blocks comprises:
providing contiguous groups consisting of a first single luma block immediately followed by a single chroma channel one block immediately followed by a second single luma block immediately followed by a single chroma channel two block until the chroma channel one blocks and chroma channel two blocks are exhausted; and
subsequently providing a contiguous group of remaining luma blocks.

7. The method of claim 1, wherein interleaving the plurality of blocks comprises:
providing one or more contiguous groups consisting of a single luma block immediately followed by a single chroma channel one block immediately followed by a chroma channel two block until the chroma channel one blocks and chroma channel two blocks are exhausted; and
subsequently providing a contiguous group of remaining luma blocks.

8. The method of claim 1, wherein the processing order comprises the luma blocks scanned spatially in a spatial wave-front order with respect to the coding unit and ordered based on neighboring dependencies among the luma blocks.

9. The method of claim 1, wherein the processing order comprises the luma blocks, the chroma channel one blocks, and the chroma channel two blocks each ordered based on multiple spatially down-left oriented scans with a first of the multiple down-left oriented scans beginning at a top-left block of the coding unit and each subsequent down-left oriented scan beginning at a block to the right of each previous down-left oriented scan.

10. The method of claim 1, wherein the processing order comprises the luma blocks ordered based on a spatial scanning of the luma blocks, the spatial scanning comprising at least a first block at a top-left luma block of the coding unit, a second block immediately to the right of the first block, a third block immediately below the first block, a fourth block immediately to the right of the second block, and a fifth block immediately to the right of the third block.

11. The method of claim 1, wherein the processing order comprises the luma blocks ordered based on a spatial scanning of the luma blocks, the spatial scanning comprising at least a first block at a top-left luma block of the coding unit, a second block immediately to the right of the first block, a third block immediately to the right of the second block, a fourth block immediately below the first block, and a fifth block immediately to the right of the fourth block.

12. A system for video coding comprising:
a decoupling buffer to store blocks of quantized residual transform coefficients corresponding to a coding unit of a video frame; and
a processor coupled to the decoupling buffer, the processor to store the blocks of quantized residual transform coefficients in a normative coding order in the decoupling buffer, the normative coding order comprising two or more immediately adjacent luma blocks followed by one or more chroma channel one blocks followed by one or more chroma channel two blocks, to retrieve the blocks from the decoupling buffer into an interleaved processing order, the processing order comprising at least a first luma block of the two or more luma blocks followed immediately by a first chroma channel one block of the one or more chroma channel one blocks, and to perform inverse quantization, inverse transform, and intra prediction operations on the plurality of blocks of quantized coefficients in the processing order to generate a reconstructed coding unit corresponding to the plurality of blocks of quantized residual transform coefficients.

13. The system of claim 12, wherein the processing order comprises the first luma block followed immediately by the first chroma channel one block followed immediately by a first chroma channel two block of the one or more chroma channel two blocks followed immediately by a second luma block of the two or more luma blocks, and wherein the first luma block corresponds to a spatially upper left region of the coding unit and the second luma block corresponds to a second region of the coding unit immediately to the right of the upper left region.

14. The system of claim 12, wherein the processing order comprises the first luma block followed immediately by the first chroma channel one block followed immediately by a second luma block of the two or more luma blocks followed immediately by a first chroma channel two block of the one or more chroma channel two blocks followed immediately by a third luma block of the two or more luma blocks, and wherein the first luma block corresponds to a spatially upper left region of the coding unit, the second luma block corresponds to a second region of the coding unit immediately to the right of the upper left region, and the third luma block corresponds to a third region of the coding unit immediately below the upper left region.

15. The system of claim 12, wherein the processor to retrieve the blocks from the decoupling buffer into the interleaved processing order comprises the processor to retrieve contiguous groups consisting of a first single luma block immediately followed by a single chroma channel one block immediately followed by a second single luma block immediately followed by a single chroma channel two block until the chroma channel one blocks and chroma channel two blocks are exhausted and to subsequently retrieve a contiguous group of remaining luma blocks.

16. The system of claim 12, wherein the processor to retrieve the blocks from the decoupling buffer into the interleaved processing order comprises the processor to retrieve one or more contiguous groups consisting of a single luma block immediately followed by a single chroma channel one block immediately followed by a chroma channel two block until the chroma channel one blocks and chroma channel two blocks are exhausted and to subsequently retrieve a contiguous group of remaining luma blocks.

17. The system of claim 12, wherein the processing order comprises the luma blocks, the chroma channel one blocks, and the chroma channel two blocks each ordered based on multiple spatially down-left oriented scans with a first of the multiple down-left oriented scans beginning at a top-left block of the coding unit and each subsequent down-left oriented scan beginning at a block to the right of each previous down-left oriented scan.

18. The system of claim 12, wherein the processing order comprises the luma blocks ordered based on a spatial scanning of the luma blocks, the spatial scanning comprising at least a first block at a top-left luma block of the coding unit, a second block immediately to the right of the first block, a third block immediately below the first block, a fourth block immediately to the right of the second block, and a fifth block immediately to the right of the third block.

19. The system of claim 12, wherein the processing order comprises the luma blocks ordered based on a spatial scanning of the luma blocks, the spatial scanning comprising at least a first block at a top-left luma block of the coding unit, a second block immediately to the right of the first block, a third block immediately to the right of the second block, a fourth block immediately below the first block, and a fifth block immediately to the right of the fourth block.

20. At least one machine readable medium comprising a plurality of instructions that, in response to being executed on a computing device, cause the computing device to perform video coding by:
receiving, for coding, a plurality of blocks of quantized residual transform coefficients corresponding to a coding unit of a video frame in a normative coding order, the normative coding order comprising two or more immediately adjacent luma blocks followed by one or more chroma channel one blocks followed by one or more chroma channel two blocks;
interleaving the plurality of blocks of quantized residual transform coefficients from the normative coding order into a processing order, the processing order comprising at least a first luma block of the two or more luma blocks followed immediately by a first chroma channel one block of the one or more chroma channel one blocks; and
performing inverse quantization, inverse transform, and intra prediction operations on the plurality of blocks of quantized coefficients in the processing order to generate a reconstructed coding unit corresponding to the plurality of blocks of quantized residual transform coefficients.

21. The machine readable medium of claim 20, wherein the processing order comprises the first luma block followed immediately by the first chroma channel one block followed immediately by a first chroma channel two block of the one or more chroma channel two blocks followed immediately by a second luma block of the two or more luma blocks, and wherein the first luma block corresponds to a spatially upper left region of the coding unit and the second luma block corresponds to a second region of the coding unit immediately to the right of the upper left region.

22. The machine readable medium of claim 20, wherein the processing order comprises the first luma block followed immediately by the first chroma channel one block followed immediately by a second luma block of the two or more luma blocks followed immediately by a first chroma channel two block of the one or more chroma channel two blocks followed immediately by a third luma block of the two or more luma blocks, and wherein the first luma block corresponds to a spatially upper left region of the coding unit, the second luma block corresponds to a second region of the coding unit immediately to the right of the upper left region, and the third luma block corresponds to a third region of the coding unit immediately below the upper left region.

23. The machine readable medium of claim 20, wherein interleaving the plurality of blocks comprises:
providing contiguous groups consisting of a first single luma block immediately followed by a single chroma channel one block immediately followed by a second single luma block immediately followed by a single chroma channel two block until the chroma channel one blocks and chroma channel two blocks are exhausted; and
subsequently providing a contiguous group of remaining luma blocks.

24. The machine readable medium of claim 20, wherein interleaving the plurality of blocks comprises:
providing one or more contiguous groups consisting of a single luma block immediately followed by a single chroma channel one block immediately followed by a chroma channel two block until the chroma channel one blocks and chroma channel two blocks are exhausted; and
subsequently providing a contiguous group of remaining luma blocks.

25. The machine readable medium of claim 20, wherein the processing order comprises the luma blocks, the chroma channel one blocks, and the chroma channel two blocks each ordered based on multiple spatially down-left oriented scans with a first of the multiple down-left oriented scans beginning at a top-left block of the coding unit and each subsequent down-left oriented scan beginning at a block to the right of each previous down-left oriented scan.
